(19) United States
(12) Patent Application Publication
(10) Pub. No.: US 2026/0369501 A1
(43) Pub. Date: Nov. 19, 2026

(54) MOVABLE CONTACT ASSEMBLY AND ELECTROMAGNETIC CONTACTOR INCLUDING SAME

(71) Applicant: LS E-MOBILITY SOLUTIONS CO., LTD., Cheongju-si, Chungcheongbuk-do (KR)

(72) Inventors: Je Hong SEO, Cheongju-si, Chungcheongbuk-do (KR); Jin Hee PARK, Cheongju-si, Chungcheongbuk-do (KR); Yeong Kyu LEE, Cheongju-si, Chungcheongbuk-do (KR)

(21) Appl. No.: 19/477,611

(22) PCT Filed: Apr. 12, 2024
(86) PCT No.: PCT/KR2024/004943

§ 371 Date: Oct. 22, 2025

(30) Foreign Application Priority Data
May 15, 2023 (KR) 10-2023-0062539

(51) Int. Cl. H01H 50/36; H01H 9/44; H01H 50/04; H01H 50/54

(52) U.S. Cl. CPC H01H 50/36; H01H 9/443; H01H 50/045; H01H 50/541

(57) ABSTRACT

A movable contact assembly and an electromagnetic contactor including same are disclosed. The movable contact assembly and the electromagnetic contactor including same, according to an aspect of the present disclosure, may comprise: a movable contact which is provided to be movable in a direction toward a stationary contact and a direction opposite to the stationary contact; a lower yoke which is located adjacent to the movable contact and is provided to be movable along with the movable contact; and an upper yoke which partially covers the movable contact and is configured to form a magnetic attractive force together with the lower yoke; and a movable frame which is coupled to the upper yoke to support the upper yoke and to which the movable contact and the lower yoke are movably coupled.

### CROSS-REFERENCE TO RELATED APPLICATIONS

This application is the National Stage filing under 35 U.S.C. 371 of International Application No. PCT/KR2024/004943, filed on Apr. 12, 2024, which claims the benefit of earlier filing date and right of priority to Korean Application No. 10-2023-0062539, filed on May 15, 2023, the contents of which are all hereby incorporated by reference herein in their entirety.

### FIELD

The disclosure relates to a movable contact assembly and an electromagnetic contactor including the same, and more particularly, to a movable contact assembly having a structure capable of improving assembly efficiency and quickly offsetting an electromagnetic repulsive force, and an electromagnetic contactor including the same.

### BACKGROUND

An electromagnetic contactor is a device which causes a contact between contacts by using a magnetic attractive force, which is generated by a current applied to an electromagnet. When the electromagnet produces a magnetic attractive force, a movable contact moves toward a fixed contact to be in contact with the fixed contact.

The fixed contact of the electromagnetic contactor is electrically connected to each of external power source and load. When the fixed contact and the movable contact are in contact, the external power source and load may be electrically connected to each other. When a current is not applied to the electromagnet any more, the magnetic attractive force produced by the electromagnet is also removed. Accordingly, the movable contact is separated from the fixed contact, so that the electrical connection between the external power source and load is released.

Typically, an electronic contactor includes a yoke. The yoke is arranged as a plurality of yokes, which generate a magnetic attractive force with each other. The plurality of yokes are arranged adjacent to the fixed contact and the movable contact. A magnetic force generated by the plurality of yokes may suppress a situation in which a fixed contact and a movable contact are arbitrarily spaced apart from each other due to an electromagnetic repulsive force, which is generated when the fixed contact and the movable contact are in contact with each other.

As is known, the magnitude of a magnetic attractive force is inversely proportional to a distance. Therefore, when the plurality of yokes are arranged farther apart from each other, the magnitude of the magnetic attractive force generated between the plurality of yokes may more decrease. In this case, it is different to quickly offset the magnetic attractive force, which is generated at the moment the fixed contact and the movable contact are in contact with each other, which may be likely to cause deterioration of contact reliability between the fixed contact and the movable contact.

Korean Registration Application No. 10-1247121 discloses an electromagnetic contactor. Specifically, an electromagnetic contactor is disclosed in which the movable contact and the fixed contact are brought into contact with or open from each other to electrically connect or disconnect external power source and load.

However, the electronic contactor disclosed in the prior art document does not provide a method of offsetting the electromagnetic repulsive force generated when the moving contact and the fixed contact are brought into contact with each other. Therefore, the electronic contactor disclosed in the prior art document does not provide a method for implementing a reliable contact state between the movable contact and the fixed contact.

Japanese Registration Application No. 2022-112552 discloses an electromagnetic contactor. Specifically, an electromagnetic contactor is disclosed, which includes a contact part located on one side in an axial direction and operates along the axial direction, and an electromagnet part located on the other side in the axial direction to open and close the contact part, and in which magnetic interference by a plunger is suppressed by arranging the plunger in the electromagnetic part.

However, the electronic contactor disclosed in the prior art document only provides a method of suppressing the magnetic interference by the plunger. That is, the prior art document does not provide a method of implementing a reliable contact state between the fixed contact and the movable contact by offsetting an electromagnetic repulsive force generated at the moment that the fixed contact and the movable contact are in contact.

Korean Patent Registration No. 10-1247121 (Apr. 1, 2013)

Japanese Patent Registration No. 2022-112552 (Aug. 3, 2022)

### SUMMARY

The disclosure is intended to solve the above problems, and an aspect of the disclosure is to provide a movable contact assembly having a structure capable of canceling an electromagnetic repulsive force, and an electromagnetic contactor including the same.

Another aspect of the disclosure is to provide a movable contact assembly having a structure capable of quickly canceling an electromagnetic repulsive force, and an electromagnetic contactor including the same.

Another aspect of the disclosure is to provide a movable contact assembly having a structure capable of reducing a required force for movement of a movable component, and an electromagnetic contactor including the same.

Another aspect of the disclosure is to provide a movable contact assembly having a structure capable of being reduced in size, and an electromagnetic contactor including the same.

Another object of the disclosure is to provide a movable contact assembly having a structure capable of stably maintaining an attractive state between components for canceling an electromagnetic repulsive force, and an electromagnetic contactor including the same.

Another aspect of the disclosure is to provide a movable contact assembly having a structure capable of suppressing arbitrary vibration or rotation of a movable contact, and an electromagnetic contactor including the same.

The problems to be solved in the disclosure may not be limited to the aforementioned, and other problems to be solved by the disclosure, which are not mentioned, will be obviously understood by a person skilled in the art based on the following description.

To achieve these and other advantages and in accordance with the purpose of the disclosure, as embodied and broadly described herein, there is provided a movable contact assembly including: a movable contact arranged to be movable in a direction toward a fixed contact and in a direction opposite to the fixed contact; a lower yoke located adjacent to the movable contact and arranged to be movable together with the movable contact; an upper yoke partially surrounding the movable contact and configured to generate a magnetic attractive force together with the lower yoke; and a movable frame coupled to the upper yoke to support the upper yoke, and to which the movable contact and the lower yoke are movably coupled.

The movable contact assembly may be provided in which the lower yoke is arranged to at least partially overlap the upper yoke along a width direction of the lower yoke.

The movable contact assembly may be provided in which the upper yoke includes: a first yoke body surrounding the movable contact on one side thereof in a height direction; and a second yoke body continuous with the first yoke body and surrounding the movable contact and the lower yoke in a width direction.

The movable contact assembly may be provided in which the second yoke body is arranged as a plurality of second yoke bodies arranged spaced apart from each other with the movable contact and the lower yoke located therebetween.

The movable contact assembly may be provided in which the second yoke body extends in the direction opposite to the fixed contact, and the lower yoke is arranged to at least partially overlap the second yoke body along the width direction of the lower yoke.

The movable contact assembly may be provided in which the upper yoke includes a yoke arm continuous with the second yoke body and surrounding the movable frame in the width direction.

The movable contact assembly may be provided in which the second yoke body and the yoke arm are each arranged as a pair spaced apart from each other along the width direction, and a distance between the pair of second yoke bodies is shorter than a distance between the pair of yoke arms.

The movable contact assembly may be provided in which the movable frame includes: a movable frame outer wall extending along an outer periphery of the movable frame, and surrounding the yoke arm in the width direction; and a yoke coupling protrusion formed protruding on the movable frame outer wall, and the upper yoke includes a frame coupling groove formed in the yoke arm and detachably coupled to the yoke coupling protrusion.

The movable contact assembly may be provided in which the frame coupling groove is formed through the yoke arm in a thickness direction of the yoke arm.

The movable contact assembly may be provided in which the frame coupling groove is recessed in one surface of the yoke arm facing the movable frame outer wall.

The movable contact assembly may be provided in which the yoke arm is arranged as a pair spaced apart from each other in the width direction, the movable frame outer wall is arranged as a pair spaced apart from each other in the width direction, and a distance between the pair of yoke arms is shorter than or equal to a distance between the pair of movable frame outer walls.

To achieve these and other advantages and in accordance with the purpose of the disclosure, as embodied and broadly described herein, there is provided an electromagnetic contactor including: a housing having a space formed therein; an opening and closing unit coupled to the housing and electrically connected to each of external power source and load; and a movable contact assembly movably accommodated in the housing, and configured to be brought into contact with the opening and closing unit to be electrically connected and spaced apart from the opening and closing unit to be electrically disconnected, wherein the opening and closing unit includes: a fixed contact having one side partially exposed to outside of the housing, and electrically connected to each of the external power source and load; and an arc chamber accommodating another side of the fixed contact, and the movable contact assembly includes: a movable contact accommodated in the arc chamber to be movable in a direction toward the fixed contact and in a direction opposite to the fixed contact; a lower yoke accommodated in the arc chamber, arranged to face the fixed contact with the movable contact located therebetween, and configured to be movable together with the movable contact; a movable frame movably supporting the movable contact point and the lower yoke; and an upper yoke accommodated in the arc chamber, fixedly coupled to the movable frame, located between the movable contact and the fixed contact to partially surround the movable contact, and generating a magnetic attraction force together with the lower yoke.

The electromagnetic contactor may be provided in which the lower yoke is arranged to be movable between a first position, at which the movable contact is in contact with and electrically connected to the fixed contact, and a second position, at which the movable contact is spaced apart from the fixed contact, and the lower yoke is arranged to at least partially overlap the upper yoke along the width direction.

The electromagnetic contactor may be provided in which the movable contact and the lower yoke are formed to have a length in one direction and a width in another direction, and the upper yoke includes: a first yoke body extending in the another direction and surrounding the movable contact in a height direction; and a second yoke body continuous with the first yoke body, and extending in the height direction to surround the movable contact and the lower yoke in the another direction.

The electromagnetic contactor may be provided in which the second yoke body is arranged as a pair continuous with corresponding longitudinal ends of the first yoke body, and the pair of second yoke bodies are configured to support the movable contact and the lower yoke in the another direction.

According to the configuration, the movable contact assembly according to an embodiment of the disclosure and the electromagnetic contactor including the same can cancel an electromagnetic repulsive force.

According to the configuration, the movable contact assembly according to an embodiment of the disclosure and the electromagnetic contactor including the same can quickly cancel an electromagnetic repulsive force.

According to the configuration, the movable contact assembly according to an embodiment of the disclosure and the electromagnetic contactor including the same can reduce a required force for movement of a movable contact.

According to the configuration, the movable contact assembly according to an embodiment of the disclosure and the electromagnetic contactor including the same can be reduced size.

According to the configuration, the movable contact assembly according to an embodiment of the disclosure and the electromagnetic contactor including the same can stably maintain an attractive state between components for canceling an electromagnetic repulsive force.

According to the configuration, the movable contact assembly according to an embodiment of the disclosure and the electromagnetic contactor including the same can suppress arbitrary vibration or rotation of a movable contact.

The effects of the disclosure are not limited to those described above, and should be understood to include all effects that can be inferred from the configuration of the invention described in the detailed description or claims of the disclosure.

### BRIEF DESCRIPTION OF THE DRAWINGS

FIG. 1 is a perspective view of an electromagnetic contactor according to an embodiment.

FIG. 2 is a cross-sectional view of the electromagnetic contactor, taken along line A-A of FIG. 1.

FIG. 3 is a cross-sectional view of the electromagnetic contactor, taken along line B-B of FIG. 1.

FIGS. 4 and 5 are exploded perspective views of the configuration of the electromagnetic contactor of FIG. 1.

FIGS. 6 and 7 are perspective views of a housing arranged in the electromagnetic contactor of FIG. 1.

FIG. 8 is a perspective view of an opening and closing unit arranged in the electromagnetic contactor of FIG. 1.

FIG. 9 is an exploded perspective view of an opening and closing unit, a core unit, and a movable contact assembly arranged in the electromagnetic contactor of FIG. 1.

FIG. 10 is a perspective view of the movable contact assembly arranged in the electromagnetic contactor of FIG. 1.

FIG. 11 is a lateral view of the movable contact assembly of FIG. 10.

FIG. 12 is a cross-sectional view of the movable contact assembly, taken along line C-C of FIG. 10.

FIG. 13 is a cross-sectional view of the movable contact assembly, taken along line D-D of FIG. 10.

FIG. 14 is an exploded perspective view of the movable contact assembly of FIG. 10.

FIG. 15 is a perspective view of a movable frame arranged in the movable contact assembly of FIG. 10.

FIG. 16 is a plan view of the movable frame of FIG. 15.

FIG. 17 is a cross-sectional view of the movable frame of FIG. 15, taken along line E-E.

FIG. 18 is a perspective view of an upper yoke arranged on the movable frame of FIG. 15.

FIG. 19 is a lateral view of the upper yoke of FIG. 18.

FIG. 20 is a front cross-sectional view of the inner structure of the electromagnetic contactor according to an embodiment in a state of electrically connecting the external power source and load.

FIG. 21 is a lateral cross-sectional view of the inner structure of the electromagnetic contactor according to an embodiment in the state of electrically connecting the external power source and load.

FIG. 22 is a front cross-sectional view of the inner structure of the electromagnetic contactor according to an embodiment in a state of electrically disconnecting the external power source and load.

FIG. 23 is a lateral cross-sectional view of the inner structure of the electromagnetic contactor according to an embodiment in the state of electrically disconnecting the external power source and load.

### DETAILED DESCRIPTION

Hereinafter, an embodiment of the disclosure will be described in detail with reference to the accompanying drawings, to be easily practiced by those skilled in the art. The disclosure may be implemented in many different forms and is not limited to the embodiment described herein. To clearly explain the disclosure, parts not related to the description have been omitted in the drawings, and the same or equivalent components are given the same reference numerals throughout the specification.

The words and terms used in the disclosure and claims are not to be construed as limited in their usual or dictionary meanings, but should be interpreted with meaning and concepts consistent with the technical idea of the disclosure according to the principle that the inventor can define terms and concepts in order to explain his or her invention in the best way.

Therefore, the embodiment described in the disclosure and the configuration illustrated in the drawings correspond to a preferred embodiment of the disclosure, and do not represent all of the technical ideas of the disclosure, so the corresponding configuration may be replaced with various equivalents and modified examples at the time that the disclosure is filed.

In the following description, descriptions of some components will be omitted to clarify features of the disclosure.

The term “communication” used in the following description means that one or more members are connected so that a fluid can flow therethrough. In an embodiment, the communication may be implemented by a member, such as a conduit, pipe, or piping. In the following description, the communication may be used to mean that one or more members are “fluidically connected” to one another.

The term “electrical connection” used in the following description refers to that one or more members are connected such that current or an electrical signal can be transmitted therebetween. In an embodiment, the electrical connection may be made in a wired form using a conductor member, or in a wireless form, such as Bluetooth, Wi-Fi, or RFID. In an embodiment, the electrical connection may include the meaning of “communication,” The term “fluid” used in the following description means any form of material that flows under external force and can change in shape or volume. In an embodiment, the fluid may be a liquid, such as water, or a gas, such as air.

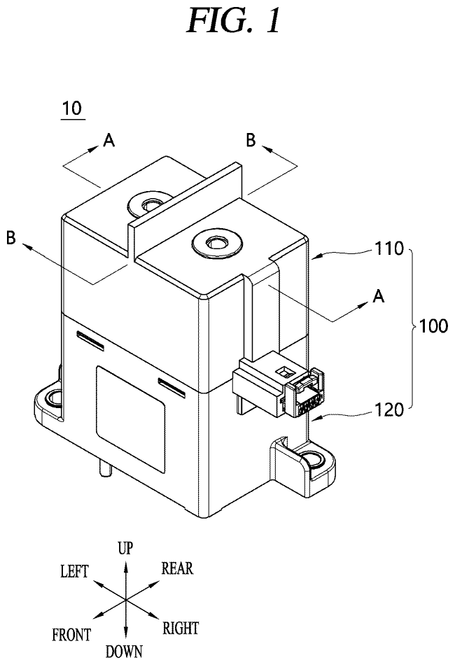

The terms “up,” “down,” “right,” “left,” “front,” and “rear” used in the following description will be understood based on a coordinate system shown in FIG. 1.

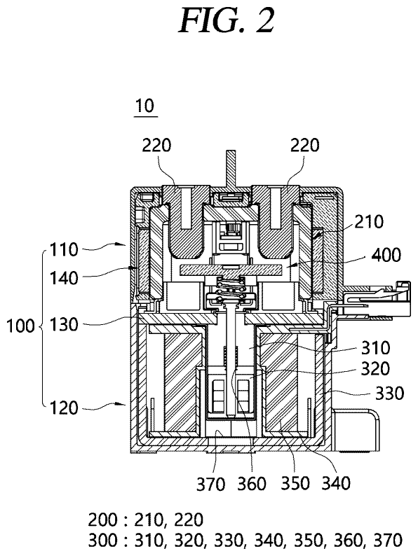

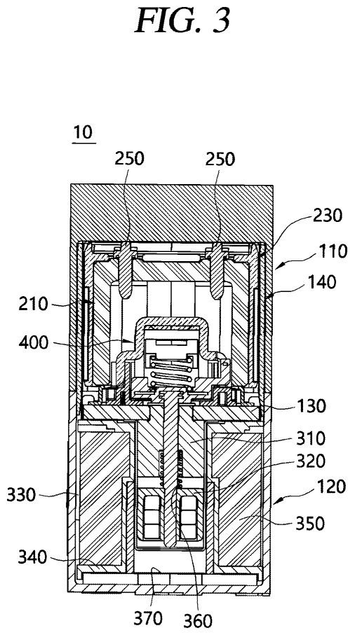

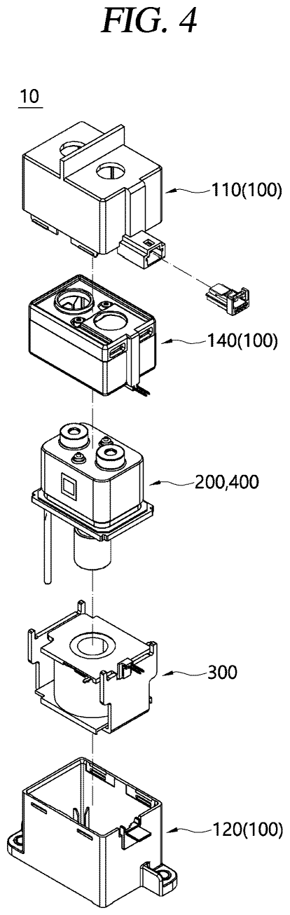

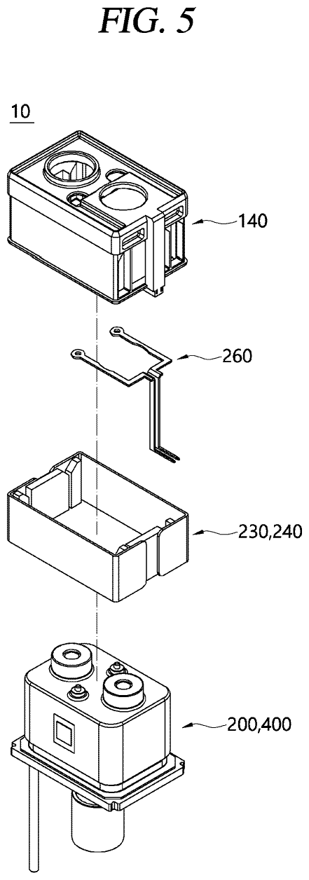

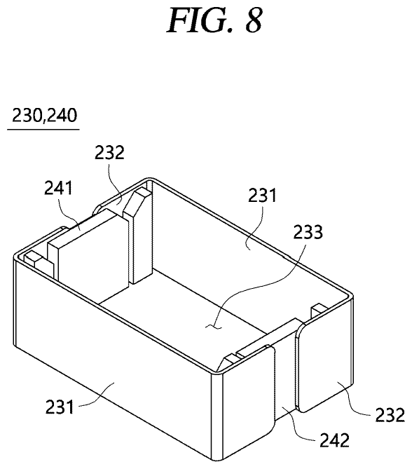

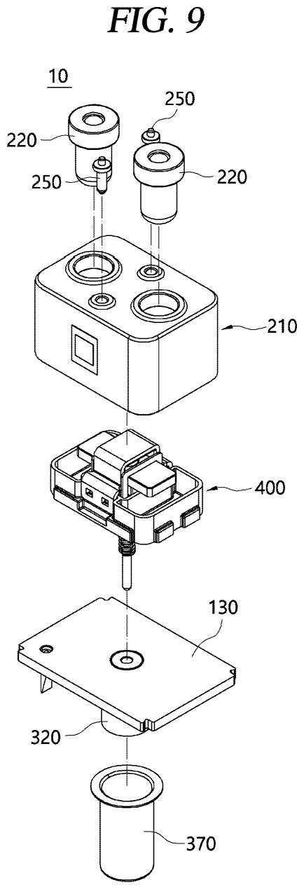

Referring to FIGS. 1 to 9, an electromagnetic contactor 10 according to an embodiment of the disclosure is shown. The electromagnetic contactor 10 is electrically connected to each of an external power source (not shown) and an external load (not shown). The electromagnetic contactor 10 may be configured to establish or release an electrical connection between the external power source (not shown) and the external load (not shown). To this end, the electromagnetic contactor 10 includes a fixed contact 220 and a movable contact 410 to be explained later.

The electromagnetic contactor 10 according to an embodiment includes an upper yoke 450 and a lower yoke 460 for offsetting an electromagnetic repulsive force, which is generated when the fixed contact 220 and the movable contact 410 are brought into contact with each other. At this time, the upper yoke 450 may be maintained at a certain height regardless of up and down movement of a component (for example, a movable shaft 430), which is arranged to be movable up and down.

Accordingly, even when the movable shaft 430 is moved up and down, the upper yoke 450 and the lower yoke 460 may be arranged to at least partially overlap each other, thereby generating a magnetic attractive force which is strong enough to attract each other. This can result in effectively offsetting an electromagnetic repulsive force which is generated when the fixed contact 220 and the movable contact 410 are brought into contact with each other.

In some embodiments, as will be described later, the upper yoke 450 is formed to at least partially surround the movable contact 410 in a direction other than the longitudinal direction. Therefore, the upper yoke 450 can suppress the movable contact 410 from being randomly rotated relative to a horizontal direction or randomly separated in a height direction.

In some embodiments, the electromagnetic contactor 10 includes a movable contact support member 470. The movable contact support member 470 is formed to surround the movable contact 410 in at least one direction. The movable contact support member 470 is configured to suppress arbitrary rotation of the movable contact 410.

Accordingly, the movable contact 410 can be suppressed from rotating in any direction relative to the fixed contact 220, thereby improving contact reliability between the movable contact 410 and the fixed contact 220.

In the shown embodiment, the electromagnetic contactor 10 includes a housing 100, an opening and closing unit 200, a core unit 300, and a movable contact assembly 400.

The housing 100 define the appearance of the electromagnetic contactor 10. A space is formed inside the housing 100 to accommodate each component of the electromagnetic contactor 10. The space of the housing 100 is electrically connected to each of the external power source (not shown) and the external load (not shown).

In an embodiment, the space of the housing 100 may accommodate the opening and closing unit 200, the core unit 300, and the movable contact assembly 400. At this time, the fixed contact 220 of the opening and closing unit 200 may be partially exposed to outside to be electrically connected to each of the external power source (not shown) and the external load (not shown).

The space of the housing 100 communicates with the outside. An arc, which is generated when a fault current flows and thereby the fixed contact 220 and the movable contact 410 are spaced apart from each other may be discharged to the outside of the housing 100.

The housing 100 may be formed of an electrical insulating material. This is to suppress the housing 100 from being arbitrarily electrically connected to other components of the electromagnetic contactor 10 or to the outside. The housing 100 may be formed of a heat-resistant material. This is to suppress damage caused by heat generated with arc. In an embodiment, the housing 100 may be formed of a synthetic resin material.

The housing 100 may have any shape which can accommodate each component of the electromagnetic contactor 10 and can be electrically connected inside thereof to each of the external power source (not shown) and the external load (not shown). In the shown embodiment, the housing 100 has a polygonal column shape with a rectangular cross-section and a vertical height.

In the shown embodiment, the housing 100 includes an upper housing 110, a lower housing 120, a support plate 130, and an inner housing 140.

The upper housing 110 defines a part of the appearance of the housing 100. The upper housing 110 is coupled with the lower housing 120 to accommodate other components of the electromagnetic contactor 10. In the shown embodiment, the upper housing 110 defines upper appearance of the housing 100.

A space is defined inside the upper housing 110. The space communicates with a space formed inside the lower housing 120. Other components of the electromagnetic contactor 10, for example, the core unit 300 and the movable contact assembly 400, may be movably accommodated in the space.

The upper housing 110 accommodates the opening and closing unit 200. At this time, the fixed contact 220 included in the opening and closing unit 200 is exposed on one side thereof in a height direction, for example, an upper side in the shown embodiment, to the outside of the upper housing 110.

The upper housing 110 partially accommodates the movable contact assembly 400. At this time, the movable contact assembly 400 may be accommodated in the upper housing 110 to be movable in the height direction, for example, in an up-down (vertical) direction. Accordingly, it can be said that the upper housing 110 accommodates the movable contact assembly 400 such that the movable contact assembly 400 is movable up and down.

The upper housing 110 is coupled to the lower housing 120. In an embodiment, the upper housing 110 may be detachably coupled to the lower housing 120. The space formed inside the upper housing 110 may communicate with the space formed inside the lower housing 120.

The lower housing 120 defines the rest of the appearance of the housing 100. The lower housing 120 is coupled to the upper housing 110 to accommodate the remaining components of the electromagnetic contactor 10. In the shown embodiment, the lower housing 120 defines lower appearance of the housing 100.

A space is formed inside the lower housing 120. The space communicates with the space formed inside the upper housing 110. Other components of the electromagnetic contactor 10, for example, the core unit 300 and the movable contact assembly 400, may be movably accommodated in the space.

The lower housing 120 accommodates the core unit 300. At this time, some components of the core unit 300 are fixed to the lower housing 120, and other components of the core unit 300 may be accommodated in the lower housing 120 to be movable up and down.

The lower housing 120 is coupled to the upper housing 110. As described above, the lower housing 120 may be detachably coupled to the upper housing 110. The space formed inside the lower housing 120 may communicate with the space formed inside the upper housing 110.

The support plate 130 is located between the upper housing 110 and the lower housing 120.

The support plate 130 partially partitions the inner space of the upper housing 110 and the inner space of the lower housing 120. The support plate 130 supports some components of the movable contact assembly 400 on one side in a height direction, for example, on a lower side in the shown embodiment.

In the shown embodiment, the support plate 130 supports the movable frame 420 from the lower side of the movable frame 420. Accordingly, it may be said that the support plate 130 also supports the upper yoke 450 and the movable contact support member 470 which are fixedly coupled to the movable frame 420.

The support plate 130 may have any shape which may partition the inner space of the upper housing 110 and the inner space of the lower housing 120. In the shown embodiment, the support plate 130 is formed in a rectangular plate shape.

A through hole is formed through the inside of the support plate 130 in a thickness direction of the support plate 130, for example, in the vertical direction. A movable shaft 430 is accommodated in the through hole of the support plate 130 to be movable up and down.

The inner housing 140 supports the auxiliary contact 250 and an auxiliary contact cable 260 which is electrically coupled to the auxiliary contact 250. The inner housing 140 is connected to each of the auxiliary contact 250 and the auxiliary contact cable 260.

The inner housing 140 is accommodated in the inner space of the upper housing 110. The inner housing 140 is located inside the upper housing 110 and the opening and closing unit 200. Specifically, the inner housing 140 is located between a magnetic support member 230 and an arc chamber 210. The arc member 210 is accommodated inside the inner housing 140. The inner housing 140 is arranged to be surrounded by the magnetic support member 230.

The inner housing 140 may have a shape corresponding to the shapes of the upper housing 110 and the opening and closing unit 200. In the shown embodiment, the inner housing 140 has a rectangular cross-section and a vertical height, but the lower side of the inner housing 140 is open. One component of the opening and closing unit 200, for example, the arc chamber 210, may be accommodated in the inner housing 140 through the lower side. The inner housing 140 surrounds the accommodated arc chamber 210 from the outside.

The inner housing 140 may include an arbitrary component which supports the auxiliary contact 250 and the auxiliary contact cable 260 and allows the inner housing 140 to be coupled to the housing 100 and the opening and closing unit 200.

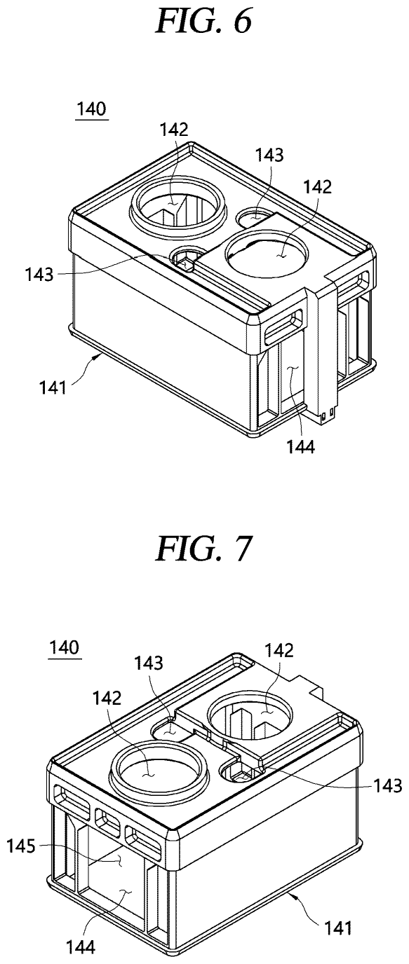

In the embodiment shown in FIGS. 6 and 7, the inner housing 140 includes an inner housing body 141, a fixed contact through hole 142, an auxiliary contact through hole 143, a magnetic member accommodating portion 144, and an arc chamber accommodation space 145.

The inner housing body 141 constitutes the body of the inner housing 140. A space, for example, the arc chamber accommodation space 145 is formed in the inner housing body 141. The arc chamber 210 may be accommodated in the space. The inner housing body 141 may be accommodated in a housing accommodation space 233 formed inside the magnetic support member 230.

The fixed contact through hole 142 and the auxiliary contact through hole 143 are formed through one side of the inner housing body 141 in the height direction, for example, an upper side in the shown embodiment. The magnetic member accommodating portion 144 is formed in each side of the inner housing body 141 in a width direction of the inner housing body 141, for example, in each of left and right sides in the shown embodiment.

The fixed contact through hole 142 is a space through which the fixed contact 220 is coupled. The fixed contact 220 may be inserted through the fixed contact through hole 142 so as to be at least partially exposed through the outside of the upper housing 110.

The fixed contact through hole 142 may have a shape corresponding to the shape of the fixed contact 220. In the shown embodiment, the fixed contact through hole 142 is a space in the shape of a disk having a circular cross-section and a thickness in the vertical direction.

The fixed contact through hole 142 may be arranged as a plurality of fixed contact through holes. The plurality of fixed contact through holes 142 may be arranged spaced apart from each other in the longitudinal direction of the inner housing body 141, for example, in the left-right direction in the shown embodiment. In the shown embodiment, the fixed contact through hole 142 is arranged as a pair of fixed contact through holes spaced apart from each other in the left-right direction.

The number and arrangement of fixed contact through holes 142 may change depending on the number and arrangement of fixed contacts 220.

The auxiliary contact through hole 143 is formed between the pair of fixed contact through holes 142.

The auxiliary contact through hole 143 is a space through which the auxiliary contact 250 is coupled. The auxiliary contact 250 may pass through the auxiliary contact through hole 143 to be at least partially exposed to the upper side of the inner housing body 141. The auxiliary contact 250 may be electrically connected to the auxiliary contact cable 260 on the upper side of the inner housing body 141.

The auxiliary contact through hole 143 may have a shape corresponding to the shape of the auxiliary contact 250. In the shown embodiment, the auxiliary contact through hole 143 is a space in the shape of a disk having a circular cross-section and a thickness in the vertical direction.

The auxiliary contact through hole 143 may be arranged as a plurality of auxiliary contact through holes. The plurality of auxiliary contact through holes 143 may be arranged spaced apart from each other in the width direction of the inner housing body 141, for example, in the left-right direction in the shown embodiment. In the shown embodiment, the auxiliary contact through hole 143 is arranged as a pair of auxiliary contact through holes which are spaced apart from each other in the front-rear direction.

The number and arrangement of auxiliary contact through holes 143 may change depending on the number and arrangement of auxiliary contacts 250.

The magnetic member accommodating portion 144 is formed in each end surface of the inner housing body 141 in a longitudinal direction of the inner housing body 141.

The magnetic member accommodating portion 144 partially accommodates a magnetic member 240 of the opening and closing unit 200. The magnetic member 240 may be exposed to the arc chamber accommodation space 145 through the magnetic member accommodating portion 144. The magnetic member 240 may generate a magnetic field in the arc chamber 210 accommodated in the arc chamber accommodation space 145.

The magnetic member accommodating portion 144 is formed in each end surface of the inner housing body 141 in the longitudinal direction of the inner housing body 141. In the shown embodiment, the magnetic member accommodating portion 144 is formed through each of a left surface and a right surface of the inner housing body 141. The magnetic member accommodating portion 144 allows the arc chamber accommodation space 145 to communicate with the outside in the longitudinal direction of the arc chamber accommodation space 145, for example, in the left-right direction.

The shape of the magnetic member accommodating portion 144 may correspond to the shape of the magnetic member 240. In the shown embodiment, the magnetic member accommodating portion 144 is formed as a rectangular plate-shaped space having a length in the front-rear direction, a height in the up-down direction, and a thickness in the left-right direction.

The magnetic member accommodating portion 144 may be arranged as a plurality of magnetic member accommodating portions. The plurality of magnetic member accommodating portions 144 may accommodate different magnetic members 240. In the shown embodiment, the magnetic member accommodating portions 144 are arranged as a pair. The magnetic member accommodating portion 144 located on the left side accommodates a first magnetic member 241. The magnetic member accommodating portion 144 located on the right side accommodates a second magnetic member 242.

The arc chamber accommodation space 145 accommodates the arc chamber 210 which forms the appearance of the opening and closing unit 200. The arc chamber accommodation space 145 may be defined as a space formed inside the inner housing body 141.

The arc chamber accommodation space 145 communicates with the fixed contact through hole 142. The fixed contact 220 accommodated in the arc chamber accommodation space 145 may be exposed to the outside of the housing 100 through the fixed contact through hole 142.

The arc chamber accommodation space 145 communicates with the auxiliary contact through hole 143. The auxiliary contact 250 accommodated in the arc chamber accommodation space 145 may be exposed to the upper side of the inner housing body 141 through the auxiliary contact through hole 143.

The arc chamber accommodation space 145 communicates with the magnetic member accommodating portion 144. The magnetic member 240 accommodated in the magnetic member accommodating portion 144 may generate a magnetic field in the arc chamber 210 accommodated in the arc chamber accommodation space 145. The generated magnetic field may form an extinguishing path for an arc which is generated when the fixed contact 220 and the movable contact 410 are spaced apart from each other.

The opening and closing unit 200 is configured to allow or block an electrical connection between the external power source (not shown) and the external load (not shown), which is electrically connected to the electromagnetic contactor 10, together with the movable contact assembly 400.

The opening and closing unit 200 is coupled to the housing 100. In some embodiments, the opening and closing unit 00 is accommodated in the inner space of the housing 100. At this time, some components of the opening and closing unit 200 may be accommodated in the space formed inside the upper housing 110. The remaining components of the opening and closing unit 200 may be accommodated in the space formed inside the lower housing 120.

The opening and closing unit 200 may be fixed to a preset position in the inner space of the housing 100. In another example, the opening and closing unit 200 is configured not to move arbitrarily. Accordingly, it will be understood that the electrical connection between the external power source (not shown) and the external load (not shown) is achieved by the movable contact assembly 400 which is movably arranged.

Some components of the opening and closing unit 200 are located on the outside of the inner housing 140. Other components of the opening and closing unit 200 are located in the arc chamber accommodation space 145 formed inside the inner housing 140.

In the shown embodiment, the opening and closing unit 200 includes an arc chamber 210, a fixed contact 220, a magnetic support member 230, a magnetic member 240, an auxiliary contact 250, and an auxiliary contact cable 260.

The arc chamber 210 accommodates the fixed contact 220 and the movable contact 410. As will be described later, the movable contact 410 may be movably accommodated in the arc chamber 210. When the fixed contact 220 and the movable contact 410 are spaced apart from each other due to a fault current, the arc chamber 210 may suppress a random leakage of the generated arc. For example, the arc chamber 210 is configured to suppress damage to other components of the electromagnetic contactor 10 due to the arc.

A magnetic field generated by the magnetic member 240 may be generated inside the arc chamber 210. The magnetic field may form a path through which the generated arc is extinguished and discharged to the outside.

The arc chamber 210 may be made of a material having high thermal resistance and high rigidity. This is to suppress damage caused by heat or pressure which is generated together with the arc. In an embodiment, the arc chamber 210 may be made of a ceramic material.

The arc chamber 210 is coupled to the inner housing 140. The arc chamber 210 is accommodated in the arc chamber accommodation space 145. The arc chamber 210 is arranged to be surrounded by the inner housing 140.

The arc chamber 210 may have any shape which can accommodate the fixed contact 220 and movably accommodate the movable contact 410. In the shown embodiment, the arc chamber 210 has a shape of a solid figure with a rectangular cross-section and a vertical height.

The fixed contact 220 is coupled to the arc chamber 210.

The fixed contact 220 is a portion where the electromagnetic contactor 10 is electrically connected to the external power source (not shown) or the external load (not shown). The fixed contact 220 is connected to each of the upper housing 110, the inner housing 140, and the arc chamber 210. The fixed contact 220 extends in the height direction of the housing 100, for example, in the up-down direction in the shown embodiment.

One side of the fixed contact 220 in the height direction of the fixed contact 220, for example, an upper side in the shown embodiment, is exposed to the outside of the upper housing 110. The external power source (not shown) or the external load (not shown) may be electrically connected to the fixed contact 220 through the upper side.

Another side of the fixed contact 220 in the height direction of the fixed contact 220, for example, a lower side in the shown embodiment, is exposed to the inner space of the arc chamber 210. The lower side of the fixed contact 220 may be brought into contact with or spaced apart from the movable contact 410.

As depicted by the name, the fixed contact 220 is coupled to each of the upper housing 110, the inner housing 140, and the arc chamber 210. Accordingly, it can be understood that the contact and separation between the fixed contact 220 and the movable contact 410 is achieved by the movement of the movable contact 410.

The fixed contact 220 may be arranged as a plurality of fixed contacts. The plurality of fixed contacts 220 may be arranged spaced apart from each other to be electrically connected to the external power source (not shown) and the external load (not shown), respectively. The plurality of fixed contacts 220 may be simultaneously brought into contact with or spaced apart from the movable contact 410 to be electrically connected to or disconnected from the movable contact 410.

In the shown embodiment, the fixed contacts 220 are arranged as a pair to be spaced apart from each other in the longitudinal direction of the housing 100, for example, in the left-right direction. The auxiliary contact 250 is located between the pair of fixed contacts 220.

The magnetic support member 230 is coupled to the magnetic member 240 to support the magnetic member 240. By means of the magnetic support member 230, the magnetic member 240 can be maintained at a preset position to generate a magnetic field inside the arc chamber 210.

The magnetic support member 230 is coupled to the inner housing 140. The magnetic support member 230 accommodates the inner housing 140 to surround the inner housing 140 from the outside in the horizontal direction, for example, from the front side, the rear side, the left side, and the right side. The magnetic support member 230 is arranged to face the arc chamber 210 with the inner housing 140 located therebetween.

The magnetic support member 230 is coupled to the magnetic member 240. In the state where the magnetic member 240 is coupled to the magnetic support member 230, the magnetic member 240 may be coupled to the arc chamber 210 which is accommodated in the inner housing 140 and the arc chamber accommodation space 145.

In the shown embodiment, the magnetic support member 230 includes a magnetic support surface 231, a magnetic exposure surface 232, and a housing accommodation space 233.

The magnetic support surface 231 constitutes one surface of the magnetic support member 230. The magnetic support surface 231 may be defined as a surface, to which the magnetic member 240 is not coupled, among surfaces of the magnetic support member 230. The magnetic support surface 231 is arranged to surround an outer surface of the inner housing body 141.

The magnetic support surface 231 may be arranged as a pair of magnetic support surfaces. The pair of magnetic support surfaces 231 may be arranged to face each other with the housing accommodation space 233 located therebetween. In the shown embodiment, the pair of magnetic support surfaces 231 are spaced apart from each other in the width direction of the housing 100, for example, in the front-rear direction. The pair of magnetic support surfaces 231 are arranged to shield a front surface and a rear surface of the inner housing body 141, respectively.

The pair of magnetic support surfaces 231 are each continuous with the magnetic exposure surface 232.

The magnetic exposure surface 232 constitutes another surface of the magnetic support member 230. The magnetic exposure surface 232 may be defined as a surface, to which the magnetic member 240 is coupled, among the surfaces of the magnetic support member 230. The magnetic exposure surface 232 is arranged to face the magnetic member accommodating portion 144 with the magnetic member 240 located therebetween. In another example, the magnetic exposure surface 232 is arranged to cover the magnetic member accommodating portion 144 from the outside.

The magnetic exposure surface 232 may be arranged as a pair. The pair of magnetic exposure surfaces 232 may be arranged to face each other with the housing accommodation space 233 located therebetween. In the shown embodiment, the pair of magnetic exposure surfaces 232 are spaced apart from each other in the longitudinal direction of the housing 100, for example, in the left-right direction. The pair of magnetic exposure surfaces 232 are each arranged to shield the magnetic member accommodating portion 144 from the outside.

The housing accommodation space 233 is a space formed inside the magnetic support member 230. The housing accommodation space 233 accommodates the arc chamber 210 which is accommodated in the inner housing 140 and the arc chamber accommodation space 145.

The housing accommodation space 233 may be defined as a space surrounded by the magnetic support surfaces 231 and the magnetic exposure surfaces 232. In the shown embodiment, the housing accommodation space 233 is shielded by the magnetic support surfaces 231 in the width direction of the housing accommodation space 233, for example, in the front-rear direction. The housing accommodation space 233 is shielded by the magnetic exposure surfaces 232 in the longitudinal direction of the housing accommodation space 233, for example, in the left-right direction.

The magnetic member 240 is exposed in the housing accommodation space 233. The magnetic member 240 may generate a magnetic field in the housing accommodation space 233 and the arc chamber 210 which is accommodated in the housing accommodation space 33.

The housing accommodation space 233 may have a shape corresponding to the shape of the inner housing body 141 or the arc chamber 210. In the shown embodiment, the housing accommodation space 233 is formed as a polygonal column-shaped space having a rectangular cross-section and a vertical height.

The magnetic member 240 generates a magnetic field in the inner space of the arc chamber 210. The magnetic field generated by the magnetic member 240 may apply a magnetic force which induces an arc. The arc may be extinguished and discharged along a path induced by the magnetic field.

The magnetic member 240 may have any shape which can generate the magnetic field in the inner space of the arc chamber 210. In an embodiment, the magnetic member 240 may be implemented as a permanent magnet or an electromagnet.

The magnetic member 240 is coupled to the inner housing 140. In some embodiments, the magnetic member 240 may be accommodated in the magnetic member accommodating portion 144 and exposed to the arc chamber accommodation space 145. An inner side of the magnetic member 240 may be supported by the arc chamber 210 which is accommodated in the arc chamber accommodation space 145.

The magnetic member 240 is coupled to the magnetic support member 230. An outer side of the magnetic member 240 may be supported by the magnetic exposure surface 232.

The magnetic member 240 may be arranged as a plurality of magnetic members. The plurality of magnetic members 240 may each be configured to generate a magnetic field in the inner space of the arc chamber 210. In the shown embodiment, the plurality of magnetic members 240 may be two magnetic members, including a first magnetic member 241 located on the left and a second magnetic member 242 located on the right.

The auxiliary contact 250 is electrically connected to a substrate member (not shown) for collecting information regarding an operating status of the electromagnetic contactor 10. Information collected from the substrate member (not shown) may be transmitted to an external controller (not shown) via the auxiliary contact 250. Accordingly, the operating status of the electromagnetic contactor 10 can be easily recognized even without disassembling the electromagnetic contactor 10.

The auxiliary contact 250 is coupled to each of the inner housing 140 and the arc chamber 210. The auxiliary contact 250 extends in the height direction of the housing 100, for example, in the up-down direction in the shown embodiment.

One side of the auxiliary contact 50 in the height direction of the auxiliary contact 250, for example, an upper side in the shown embodiment, is exposed to the upper side of the inner housing body 141 through the auxiliary contact through hole 143. The auxiliary contact 250 may be electrically connected to the auxiliary contact cable 260 through the upper side.

The auxiliary contact 250 is located between the pair of fixed contacts 220. In the shown embodiment, the auxiliary contact 250 is located between the pair of fixed contacts 220 along the longitudinal direction of the housing 100, for example, in the left-right direction.

The auxiliary contact 250 may be arranged as a plurality of auxiliary contacts. The plurality of auxiliary contacts 250 may be arranged spaced apart from each other to be electrically connected to a plurality of auxiliary contact terminals 472, respectively. In the shown embodiment, the auxiliary contact 250 is arranged as a pair to be spaced apart from each other in the width direction of the housing 100, for example, in the front-rear direction.

The auxiliary contact cable 260 electrically connects the auxiliary contact 250 to the external controller (not shown). The auxiliary contact cable 260 is electrically connected to each of the auxiliary contact 250 and the external controller (not shown).

The auxiliary contact cable 260 is coupled to the inner housing 140. A portion of the auxiliary contact cable 260 may be supported by being coupled to an outer surface of the inner housing body 141. The auxiliary contact cable 260 may be electrically connected to the auxiliary contact 250 which is inserted through the auxiliary contact through hole 143.

The core unit 300 supplies a driving force for the movable contact 410 to move toward the fixed contact 220 when external control power is applied. The core unit 300 supplies a driving force for the movable contact 410 in contact with the fixed contact 220 to move away from the fixed contact 220 when the external control power is cut off.

The core unit 300 is coupled to the housing 100. In some embodiments, some components of the core unit 300 are fixedly arranged in the space formed inside the lower housing 120. Other components of the core unit 300 are movably arranged in the space formed inside the lower housing 120. At this time, the other components of the core unit 300 may be arranged to be movable in the height direction of the lower housing 120, for example, in the up-down direction.

The core unit 300 is coupled to the movable contact assembly 400. A movable core 320 to be described later may be coupled to the movable shaft 430 of the movable contact assembly 400 to be movable together with the movable shaft 430.

In the shown embodiment, the core unit 300 includes a fixed core 310, a movable core 320, a core yoke 330, a bobbin 340, coils 350, a return spring 360, and a cylinder 370.

The fixed core 310 is magnetized by applied control power and supplies a magnetic attractive force to the movable core 320. By the magnetic attractive force applied by the fixed core 310, the movable core 320 and the movable shaft 430 coupled to the movable core 30 may move toward the fixed core 310.

Accordingly, the movable contact 410 coupled to the movable shaft 430 can also move together, so that the movable contact 410 and the fixed contact 220 can be brought into contact with each other and electrically connected.

The fixed core 310 may be have any shape which can be magnetized by external control power and apply a magnetic attractive force to the movable core 320. In an embodiment, the fixed core 310 may be implemented as an electromagnet.

The fixed core 310 is coupled to the support plate 130. The fixed core 310 is accommodated in a space formed inside the cylinder 370. One side of the fixed core 310 in the height direction of the fixed core 310, for example, an upper side in the shown embodiment, is fixedly coupled to the support plate 130. Another side of the fixed core 310 in the height direction, for example, a lower side in the shown embodiment, is elastically supported by the return spring 360.

The movable core 320 is moved toward the fixed core 310 by a magnetic attractive force which is applied by the fixed core 310. The movable core 320 is moved away from the fixed core 310 by an elastic force which is applied by the return spring 360.

The movable core 320 is accommodated in the space formed inside the cylinder 370. The movable core 320 is arranged to face the support plate 130 with the fixed core 310 located therebetween. In the shown embodiment, the movable core 320 is located below the fixed core 310.

The movable core 320 is coupled to the movable shaft 430. When the movable core 320 moves, the movable shaft 430 may also move. Accordingly, some components included in the movable contact assembly 400 may move together with the movable core 320.

The movable core 320 is elastically supported by the return spring 360. In some embodiments, one side of the movable core 30 in the height direction of the movable core 320, for example, an upper side in the shown embodiment, is supported by one end portion of the return spring 360 in the height direction of the return spring 360.

The movable core 320 may have any shape which can be moved toward the fixed core 310 by a magnetic attractive force which is applied by the fixed core 310. In an embodiment, the movable core 320 may be made of a metal material, such as magnetizable iron (Fe).

The core yoke 330 functions as a fixed core with respect to a magnetic field which the coils 350 generates by the applied control power. The core yoke 330 may be magnetized by the generated magnetic field to function as an electromagnet.

The core yoke 330 is coupled to the housing 100. In some embodiments, the core yoke 330 is accommodated in the inner space of the lower housing 120. The support plate 130 is located on one side of the core yoke 330 in the height direction of the core yoke 330, for example, on an upper side in the shown embodiment.

The core yoke 330 is arranged to surround the bobbin 340 and the coils 350. The core yoke 330 may be located adjacent to the coil 350 and may be magnetized by the magnetic field generated by the coils 350.

The bobbin 340 supports the coils 350. The coils 350 may be accommodated in the housing 100 while being wound on the bobbin 340. For example, the bobbin 340 functions as a type of bobbin.

The bobbin 340 is coupled to the housing 100. In some embodiments, the bobbin 340 is accommodated in the space formed inside the lower housing 120. As described above, the bobbin 340 is located radially inside the core yoke 330. A hollow hole may be formed inside the bobbin 340 so that the cylinder 370 is accommodated.

The coils 350 generate a magnetic field by receiving control power from the outside. The core yoke 330 may be magnetized by the magnetic field generated by the coils 350, thereby generating a magnetic force for moving the movable core 320 toward the fixed core 310.

The coils 350 are coupled to the housing 100. In some embodiments, the coils 350 are accommodated in the space formed in the lower housing 120. The coils 350 are coupled to the bobbin 340. The coils 350 may be wound around an outer periphery of the bobbin 340.

The return spring 360 applies a restoring force for the movable core 320, which has moved toward the fixed core 310, to move away from the fixed core 310. The return spring 360 is located between the fixed core 310 and the movable core 320. The return spring 360 is accommodated in the inner space of the cylinder 370.

The return spring 360 may have any shape which can store a restoring force, in response to the movable core 320 moving toward the fixed core 310, and apply the stored restoring force to the movable core 320 when the control power is not applied any more. In the shown embodiment, the return spring 360 is configured as a coil spring.

In the embodiment, the return spring 360 extends in the height direction of the housing 100, for example, in the up-down direction. One end of the return spring 360 in the extension direction of the return spring 360 is in contact with the fixed core 310. Another end of the return spring 360 in the extension direction is in contact with the movable core 320. For example, the return spring 360 elastically supports the movable core 320.

In the embodiment, a hollow which extends in the longitudinal direction, for example, in the up-down direction, may be formed inside the return spring 360. The movable shaft 430 may be inserted through the hollow.

The cylinder 370 movably accommodates the movable core 320 and the movable shaft 430 coupled to the movable core 320. In the shown embodiment, the cylinder 370 may extend in the height direction of the housing 100, for example, in the up-down direction, so that the movable core 320 and the movable shaft 430 are accommodated to be movable up and down.

The cylinder 370 is coupled to the bobbin 340. The cylinder 370 may be located in the hollow formed through the inside of the bobbin 340.

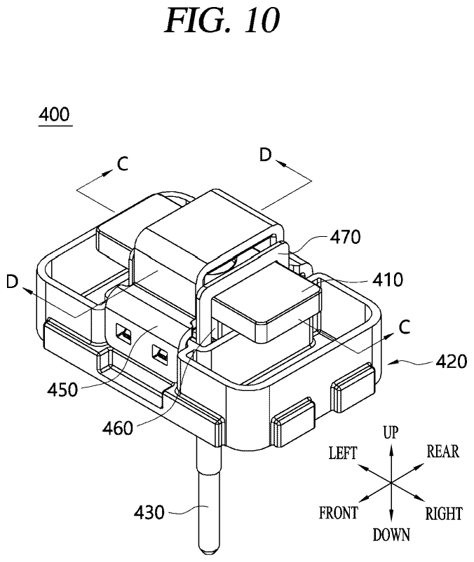

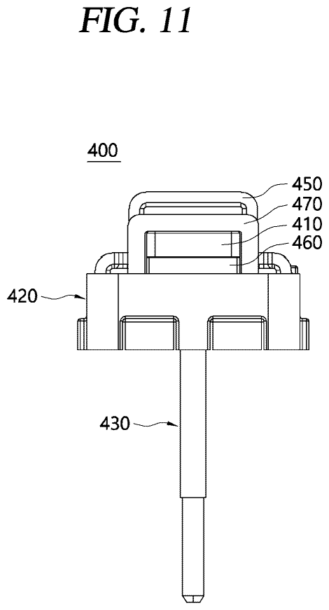

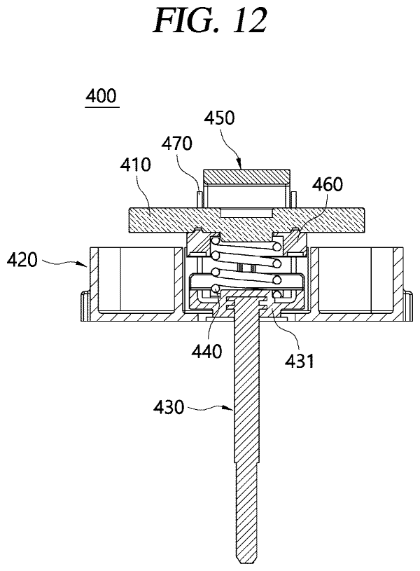

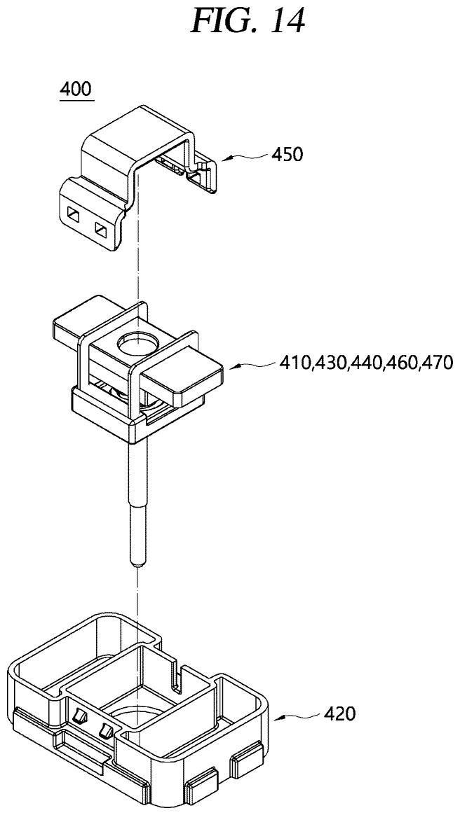

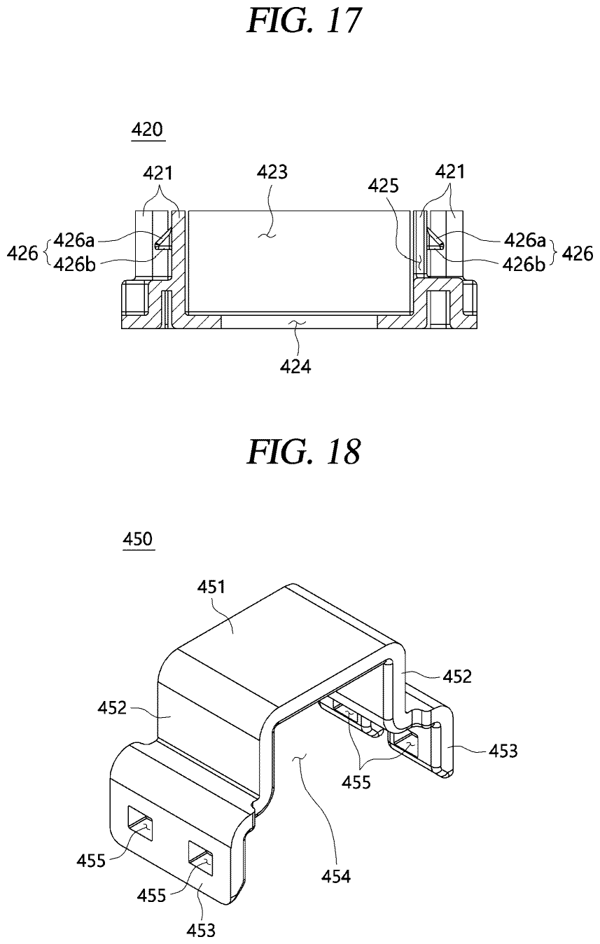

Referring to FIGS. 10 to 19, the electromagnetic contactor 10 according to an embodiment includes the movable contact assembly 400.

The movable contact assembly 400 according to an embodiment includes a plurality of yokes 450 and 460 configured to offset an electromagnetic repulsive force, which is generated when the fixed contact 220 and the movable contact 410 are brought into contact with each other. In particular, one yoke 450 of the plurality of yokes 450 and 460 may be maintained at a preset position regardless of the movement of the movable contact 410.

Accordingly, an area in which the plurality of yokes 450 and 460 are arranged to overlap each other can increase, compared to the case where the plurality of yokes 450 and 460 are all moved. Therefore, the magnetic attractive force between the plurality of yokes 450 and 460 can increase, so that the electromagnetic repulsive force generated between the fixed contact 220 and the movable contact 410 can be effectively offset.

One yoke 450 of the plurality of yokes 450 and 460 is formed to at least partially surround the movable contact 410. Accordingly, the one yoke 450 can also perform the role of supporting the movable contact 410 in the horizontal and vertical directions.

This can result in suppressing arbitrary rotation or vibration of the movable contact 410, thereby implementing reliability of a contact and electrically-connected state between the movable contact 410 and the fixed contact 220.

In the shown embodiment, the movable contact assembly 400 includes a movable contact 410, a movable frame 420, a movable shaft 430, a movable spring 440, an upper yoke 450, a lower yoke 460, and a movable contact support member 470.

The movable contact 410 is brought into contact with or spaced apart from the fixed contact 220. The movable contact 410 may be brought into contact with or spaced apart from the plurality of fixed contacts 220 simultaneously. When the movable contact 410 and the fixed contact 220 are brought into contact with each other, an external power source (not shown) and an external load (not shown) which are electrically connected to the electromagnetic contactor 10 may be electrically connected to each other.

The movable contact 410 is accommodated in the housing 100. In some embodiments, the movable contact 410 is movably accommodated in the arc chamber 210 which is accommodated in the inner space of the upper housing 110. In an embodiment, the movable contact 410 may be accommodated inside the arc chamber 210 so as to be movable in the height direction of the upper housing 110, for example, in the up-down direction.

The movable contact 410 is movably coupled to the movable frame 420. The movable contact 410 may move relative to the movable frame 420. For example, as will be described later, the movable frame 420 is not arbitrarily moved by being coupled to the support plate 130.

The movable core 410 is coupled to the movable shaft 430. When the movable core 320 coupled to the movable shaft 430 moves, the movable contact 410 may also move together.

The movable contact 410 is coupled to the movable spring 440. In some embodiments, the movable contact 410 is elastically supported by the movable spring 440. In the shown embodiment, a lower portion of the movable contact 410 is elastically supported by the movable spring 440.

The movable contact 410 is located adjacent to the upper yoke 450. The movable contact 410 may be arranged to be at least partially surrounded by the upper yoke 450. In the shown embodiment, one side of the movable contact 410 in the height direction of the movable contact 410, for example, an upper side, and each side in the width direction, for example, a front side and a rear side, are surrounded by the upper yoke 450.

The movable contact 410 is located adjacent to the lower yoke 460. The movable contact 410 may be in contact with the lower yoke 460 so as to be supported by the lower yoke 460. In the shown embodiment, a lower portion of the movable contact 410 is supported by the lower yoke 460. The movable contact 410 may move together with the lower yoke 460.

The movable contact 410 may be supported by the movable contact support member 470. As will be described later, the movable contact support member 470 is formed to surround the movable contact 410 at at least one position along the longitudinal direction of the movable contact 410. In the shown embodiment, one side of the movable contact 410 in the height direction of the movable contact 410, for example, the upper side, and each side in the width direction, for example, the front side and the rear side, are surrounded by the movable contact support member 470.

As described above, the movable contact 410 may also be surrounded and supported by the upper yoke 450. Therefore, even in an embodiment in which the movable contact support member 470 is not arranged, arbitrary rotation or movement of the movable contact 410 can be suppressed. Accordingly, as described above, the movable contact 410 and the fixed contact 220 can reliably make contact and electrical connection therebetween.

The movable contact 410 may have any shape which is electrically connected by being brought into contact with the plurality of fixed contacts 220 simultaneously. In the shown embodiment, the movable contact 410 has a polygonal column shape having a length in the left-right direction, a width in the front-rear direction, and a height in the up-down direction.

At this time, the length of the movable contact 410 in the extension direction of the movable contact 410, for example, in the left-right direction, may be at least a distance by which the pair of fixed contacts 220 are spaced apart from each other. By the structure, the movable contact 410 can be simultaneously in contact with the plurality of fixed contacts 220.

The movable frame 420 is located adjacent to the movable contact 410.

The movable frame 420 is a component, which is mounted on the support plate 130, among the components of the movable contact assembly 400. The movable frame 420 may be fixed to the support plate 130 so as not to move arbitrarily.

The movable frame 420 may be located below the movable contact 410. The movable frame 420 may be located adjacent to the movable contact 410 so as to limit a downward movement distance of the movable contact 410.

A through hole is formed through the inside of the movable frame 420. The movable shaft 430 may be coupled through the through hole to be movable up and down.

The movable frame 420 is coupled to the upper yoke 450. In an embodiment, the movable frame 420 may be detachably coupled to the upper yoke 450. The upper yoke 450 coupled to the movable frame 420 can surround and support the movable contact 410 in the height direction and the width direction.

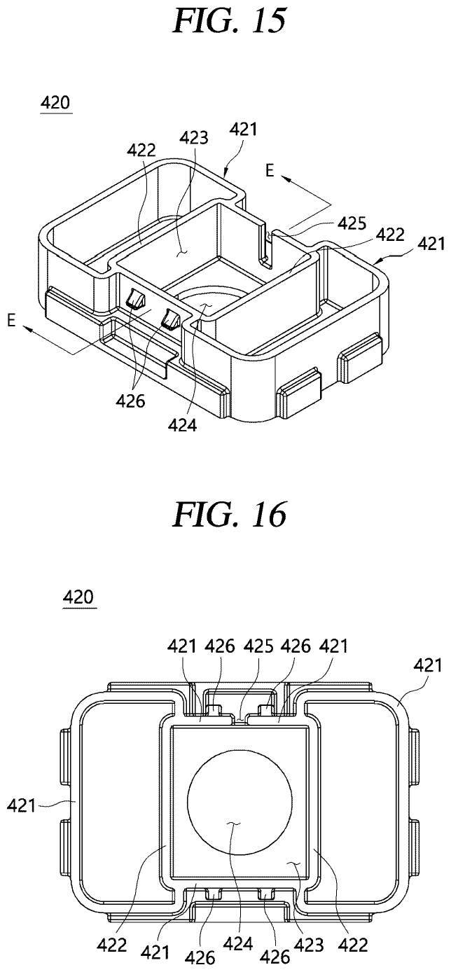

In the embodiment shown in FIGS. 15 to 17, the movable frame 420 includes a movable frame outer wall 421, a movable frame inner wall 422, a movable shaft accommodating portion 423, a movable shaft coupling portion 424, a cut groove 425, and a yoke coupling protrusion 426.

The movable frame outer wall 421 constitutes a part of the appearance of the movable frame 420. The movable frame outer wall 421 at least partially surrounds a space formed inside the movable frame 420. The movable frame outer wall 421 extends along an outer periphery of the movable frame 420.

The movable frame outer wall 421 may be constituted with a plurality of consecutive parts. The plurality of parts constituting the movable frame outer wall 421 may be arranged in parallel in the width direction of the movable frame 420, for example, in the left-right direction in the shown embodiment.

The movable frame outer wall 421 is continuous with the movable frame inner wall 422. In the shown embodiment, the movable frame inner wall 422 is arranged between a movable frame outer wall 421 located on the left and a movable frame outer wall 421 located on the right.

The movable frame outer wall 421 may extend in the longitudinal direction and width direction of the movable frame 420. In the shown embodiment, the movable frame outer walls 421 are configured to include one pair extending in the left-right direction and spaced apart from each other in the front-back direction, and another pair continuous with the one pair extending in the front-back direction and spaced apart from each other in the left-right direction.

At this time, parts of the pair of movable frame outer walls 421 extending in the left-right direction may surround the movable shaft accommodating portion 423 in the width direction, for example, in the front-back direction. Yoke coupling protrusions 426 protrude from outer surfaces of the parts of the pair of movable frame outer walls 421.

At this time, the parts of the pair of movable frame outer walls 421 extending in the left-right directions may be located inward compared to the remaining parts of the pair of movable frame outer walls 421. In other words, a distance by which the parts of the pair of movable frame outer walls 421 are spaced apart in the front-rear direction may be shorter than a distance by which the remaining parts are spaced apart in the front-rear direction.

The movable frame inner wall 422 constitutes another part of the appearance of the movable frame 420. The movable frame inner wall 422 divides a space, which is defined by being surrounded by the movable frame outer walls 421, into a plurality of small spaces. At this time, some of the plurality of small spaces defined by the movable frame inner wall 422 may be defined as movable shaft accommodating portions 423.

The movable frame inner wall 422 is located in a space surrounded by the movable frame outer walls 421 and is continuous with the movable frame outer walls 421. The movable frame inner wall 422 extends in the width direction of the movable frame 420, for example, in the front-rear direction in the shown embodiment. Opposite ends of the movable frame inner wall 422 in the extension direction of the movable frame inner wall 422 are continuous with the corresponding movable frame outer walls 421.

The movable frame inner wall 422 may be arranged as a plurality of movable frame inner walls. The plurality of movable frame inner walls 422 may be spaced apart from each other, to each partially surround the movable shaft accommodating portion 423. In the shown embodiment, the movable frame inner wall 422 is arranged as a pair spaced apart from each other in the longitudinal direction of the movable frame 420, for example, in the left-right direction.

The space surrounded by the parts of the pair of movable frame outer walls 421 and the pair of movable frame inner walls 422 is defined as the movable shaft accommodating portion 423.

The movable shaft accommodating portion 423 movably accommodates the shaft holder 431 of the movable shaft 430. The movable shaft 430 can move in the direction toward the fixed contact 220 and in the direction away from the fixed contact 220, for example, in the up-down direction in the shown embodiment, while the shaft holder 431 is accommodated in the movable shaft accommodating portion 423.

The shape of the movable shaft accommodating portion 423 may correspond to the shape of the shaft holder 431. In the shown embodiment, the movable shaft accommodating portion 423 is formed as a space having a three-dimensional figure shape which has a length in the left-right direction, a width in the front-rear direction, and a height in the up-down direction.

The movable shaft accommodating portion 423 is formed inside the movable frame 420. The movable shaft accommodating portion 423 may be defined as a space surrounded by the movable frame outer walls 421 and the movable frame inner walls 422.

In the shown embodiment, the movable shaft accommodating portion 423 is surrounded by the parts of the movable frame outer walls 421 in the width direction of the movable shaft accommodating portion 423, for example, in the front-rear direction. The movable shaft accommodating portion 423 is also surrounded by the movable frame inner walls 422 in the longitudinal direction of the movable shaft accommodating portion 423, for example, in the left-right direction.

The movable shaft accommodating portion 423 may be open on one side thereof in the height direction, for example, on an upper side in the shown embodiment. The movable shaft 430 may move toward the upper side. Another side of the movable shaft accommodating portion 423 in the height direction, for example, a lower side in the shown embodiment, communicates with the movable shaft coupling portion 424.

The movable shaft coupling portion 424 movably accommodates the movable shaft 430. The movable shaft 430 may be coupled through the movable shaft coupling portion 424 to move in the direction toward the fixed contact 220 and in the direction away from the fixed contact 220, for example, in the up-down direction in the shown embodiment.

The movable shaft coupling portion 424 is formed through the inside of the movable frame 420. In the shown embodiment, the movable shaft coupling portion 424 is formed through one surface of the movable frame 420, for example, a surface surrounding the movable shaft accommodating portion 423 on one side in the height direction, for example, on the lower side in the shown embodiment.

The movable shaft coupling portion 424 communicates with the movable shaft accommodating portion 423. The movable shaft coupling portion 424 communicates with one side of the movable shaft accommodating portion 423 in the height direction of the movable shaft accommodating portion 423, for example, the lower side in the shown embodiment.

The movable shaft coupling portion 424 may have any shape capable of movably accommodating the movable shaft 430. In the shown embodiment, the movable shaft coupling portion 424 is a space in the shape of a disk having a circular cross-section and a thickness in the up-down direction.

The movable shaft coupling portion 424 may have a cross-sectional area which is less than a cross-sectional area of the shaft holder 431. Accordingly, the body of the movable shaft 430, for example, a portion extending in the up-down direction, may be movably inserted through the movable shaft coupling portion 424, but the shaft holder 431 cannot pass through the movable shaft coupling portion 424.

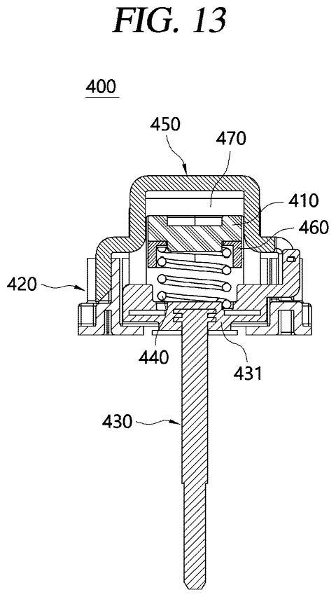

The cut groove 425 forms a passage through which a protrusion arranged on the shaft holder 431 passes (see FIG. 13). The cut groove 425 communicates with the outside of the movable shaft accommodating portion 423. The protrusion arranged on the shaft holder 431 accommodated in the movable shaft accommodating portion 423 may be exposed to the outside of the movable frame 420 through the cut groove 425.

The cut groove 425 is formed through the movable frame outer wall 421. The cut groove 425 extends in the height direction of the movable frame 420, for example, in the up-down direction in the shown embodiment. The cut groove 425 may be open on one side thereof in the height direction, for example, on an upper side in the shown embodiment. By the structure of the cut groove 425, an upward movement distance of the shaft holder 431 is not limited, but a downward movement distance can be limited.

The yoke coupling protrusions 426 are configured to couple the movable frame 420 with the upper yoke 450. The yoke coupling protrusions 426 are detachably coupled to frame coupling grooves 455 formed in the upper yoke 450.

The yoke coupling protrusions 426 are coupled to the movable frame outer walls 421. The yoke coupling protrusions 426 may protrude from one surface of the corresponding movable frame outer wall 421. In the shown embodiment, the yoke coupling protrusions 426 protrude from the outer surfaces of the parts of the movable frame outer walls 421, for example, portions surrounding the movable shaft accommodating portion 423 on the front and rear sides.

The yoke coupling protrusion 426 may be arranged as a plurality of yoke coupling protrusions. The plurality of yoke coupling protrusions 426 may be arranged on each of the parts of the movable frame outer walls 421. In the embodiment, the plurality of yoke coupling protrusions 426 arranged on each movable frame outer wall 421 may be arranged spaced apart from each other.

In the shown embodiment, the yoke coupling protrusions 426 include a pair of yoke coupling protrusions arranged on a front surface of the part of the movable frame outer wall 421 located on the front side, and a pair of yoke coupling protrusions 426 arranged on a rear surface of the part of the movable frame outer wall 421 located on the rear side. At this time, each pair of yoke coupling protrusions 426 are spaced apart from each other in the longitudinal direction of the movable frame 420, for example, in the left-right direction in the shown embodiment.

As described above, the cut groove 425 is formed inside the part of the movable frame outer wall 421 located on the rear side. In the embodiment, the pair of yoke coupling protrusions 426 located on the rear side may be arranged to face each other with the cut groove 425 therebetween.

The yoke coupling protrusions 426 may have any shape which can be detachably coupled to the frame coupling grooves 455. In the shown embodiment, each of the yoke coupling protrusions 426 includes a first protrusion extension portion 426a extending outward from the movable frame outer wall 421 to be downwardly inclined, and a second protrusion extension portion 426b continuous with the first protrusion extension portion 426a at a certain angle and extending toward the movable frame outer wall 421.

Accordingly, when the upper yoke 450 moves in the direction toward the movable frame 420, for example, downward in the shown embodiment, the yoke coupling protrusion 426 can be easily accommodated in the frame coupling groove 455 by the first protrusion extension portion 426a which extends to be inclined. On the other hand, the yoke coupling protrusion 426 accommodated in the frame coupling groove 455 is suppressed from being randomly pulled out of the frame coupling groove 455 by the second protrusion extension portion 426b extending horizontally.

As a result, the shape of the yoke coupling protrusion 426 can allow the movable frame 420 and the upper yoke 450 to be easily coupled, while the coupling state can be stably maintained.

The movable shaft 430 transmits the movement of the movable core 30 to the movable contact 410. The movable shaft 430 may be coupled to the movable core 320 and the movable contact 410 so as to move together.

The movable shaft 430 extends in the height direction of the housing 100, for example, in the up-down direction in the shown embodiment. One side of the movable shaft 430 in the height direction of the movable shaft 430, an upper side in the shown embodiment, is coupled to the movable contact 410 through a shaft holder 431. Another side of the movable shaft 430 in the height direction of the movable shaft 430, in the shown embodiment, a lower side, is coupled to the movable core 320.

The movable contact 430 is accommodated in the housing 100. In some embodiments, the movable shaft 430 is partially accommodated in each space formed inside the upper housing 110 and the lower housing 120.

The movable shaft 430 is coupled to the support plate 130. In some embodiments, the movable shaft 430 is movably inserted through an opening which is formed through the inside of the support plate 130.

The movable shaft 430 is coupled to the movable core 320. The movable shaft 430 is inserted through a hollow which is formed in the return spring 460, and is movably accommodated in the cylinder 370.

The movable shaft 430 is coupled to the movable contact 410. The movable shaft 430 may move together with the movable contact 410.

The movable shaft 430 is coupled to the movable frame 420. In some embodiments, the movable shaft 430 is inserted through the movable shaft coupling portion 424 which is formed inside the movable frame 420. The movable shaft 430 is movably coupled to the movable frame 420.

The movable shaft 430 supports the movable spring 440. In some embodiments, the movable shaft 430 is in contact with one side of the movable spring 440 in the longitudinal direction of the movable spring 440, for example, the lower side. Accordingly, the movable contact 410 and the lower yoke 460 can be elastically supported by the movable spring 440.

The movable shaft 430 is coupled to the movable contact support member 470. The movable shaft 430 may move together with the movable contact support member 470.

In the shown embodiment, the movable shaft 430 includes a shaft holder 431.

The shaft holder 431 is a portion where the movable shaft 430 is coupled with other components of the movable contact assembly 400. In the shown embodiment, the shaft holder 431 is coupled to the movable contact 410, the movable spring 440, the lower yoke 460, and the movable contact support member 470.

In some embodiments, the movable contact 410 and the lower yoke 460 are located to face the shaft holder 431 with the movable spring 440 arranged therebetween. The movable contact 410 and the lower yoke 460 are elastically supported by the movable spring 440.

The movable spring 440 is mounted on one surface, facing the movable contact 410, for example, an upper surface in the shown embodiment, among surfaces of the shaft holder 431. Furthermore, the movable contact support member 470 is directly coupled to the shaft holder 431.

The shaft holder 431 is located on one side of the movable shaft 430 in the longitudinal direction of the movable shaft 430, for example, on an upper side in the shown embodiment. The shaft holder 431 is located between the support plate 130 and the movable frame 420. At this time, the shaft holder 431 may be formed to have a cross-sectional area, which exceeds a cross-sectional area of the through hole formed inside the support plate 130 and the movable shaft coupling portion 424 formed inside the movable frame 420.

Accordingly, the shaft holder 431 cannot pass through the through hole formed inside the support plate 130 or the movable shaft coupling portion 424 and can be maintained in a state of being accommodated in the movable shaft accommodating portion 423.

A position at which the movable shaft 430 is movable in a direction opposite to the fixed contact 220, for example, downward in the shown embodiment, may be limited to a position at which the movable shaft 430 is in contact with the movable frame 420 or a position at which the protrusion formed on the shaft hole 431 is in contact with a lower end of the cut groove 425.

The movable spring 440 elastically supports the movable contact 410 and the lower yoke 460. The movable spring 440 is located between the movable contact 410 and the lower yoke 460 and the shaft holder 431. The movable spring 440 is located below the movable contact 410 and the lower yoke 460.

The movable spring 440 extends between the shaft holder 431 and the lower yoke 460. In the shown embodiment, the movable spring 440 extends in the extension direction of the movable shaft 430, for example, in the up-down direction. One end of the movable spring 440 in the extension direction of the movable spring 440, for example, an upper end, is in contact with the lower yoke 460. Another end of the movable spring 440 in the extension direction of the movable spring 440, for example, a lower end, is supported by the shaft holder 431.

When the movable shaft 430 moves toward the fixed contact 220, the movable spring 440 may be pressed by the shaft holder 431 to move together while storing a restoring force. The movable contact 410 can be pressed toward the fixed contact 220 by the stored restoring force, thereby stably maintaining the contact state between the fixed contact 20 and the movable contact 410.

The upper yoke 450 generates a magnetic attractive force together with the lower yoke 460. The magnetic attractive force generated by the upper yoke 450 and the lower yoke 460 can offset an electromagnetic repulsive force which is generated when the fixed contact 220 and the movable contact 410 are brought into contact with each other. Accordingly, the contact state between the fixed contact 220 and the movable contact 410 can be achieved and stably maintained.

The upper yoke 450 may have any shape which can generate the magnetic attractive force together with the lower yoke 460. In an embodiment, the upper yoke 450 may be made of a magnetic substance having magnetism, for example, may be implemented as a permanent magnet.

The upper yoke 450 is located adjacent to the movable contact 410. At this time, the upper yoke 450 may be arranged to surround at least a portion of the movable contact 410. In the shown embodiment, the upper yoke 450 partially surrounds the movable contact 410 in the height and width directions. For example, in the embodiment, the upper yoke 450 may surround each of a portion of the upper side and portions of a front side and a rear side of the movable contact 410.

In the embodiment, the upper yoke 450 may support the movable contact 410 in each of the height and width directions. Accordingly, even when the movable contact support member 470 to be described later is not arranged, arbitrary rotation or movement of the movable contact 410 can be suppressed by the upper yoke 450.

The upper yoke 450 is located adjacent to the lower yoke 460. The upper yoke 450 may be arranged to surround the lower yoke 460 from the outside. In the shown embodiment, the upper yoke 450 partially surrounds the lower yoke 460 in the height and width directions. For example, in the embodiment, the upper yoke 450 may surround each of a portion of the upper side and portions of a front side and a rear side of the lower yoke 460.

In particular, the electromagnetic contactor 10 according to an embodiment may be configured to minimize a separation distance between the upper yoke 450 and the lower yoke 460. This is achieved by the upper yoke 450 being coupled to the movable frame 420 and maintained in a preset position regardless of the movement of the movable shaft 430.

The upper yoke 450 may be arranged as a single number. The single upper yoke 450 may be detachably coupled to the movable frame 420 to at least partially surround and support the movable contact 410 and the lower yoke 460.

The upper yoke 450 may have any shape which can at least partially surround the movable contact 410 and the lower yoke 460 and generate a magnetic attractive force with the lower yoke 460.

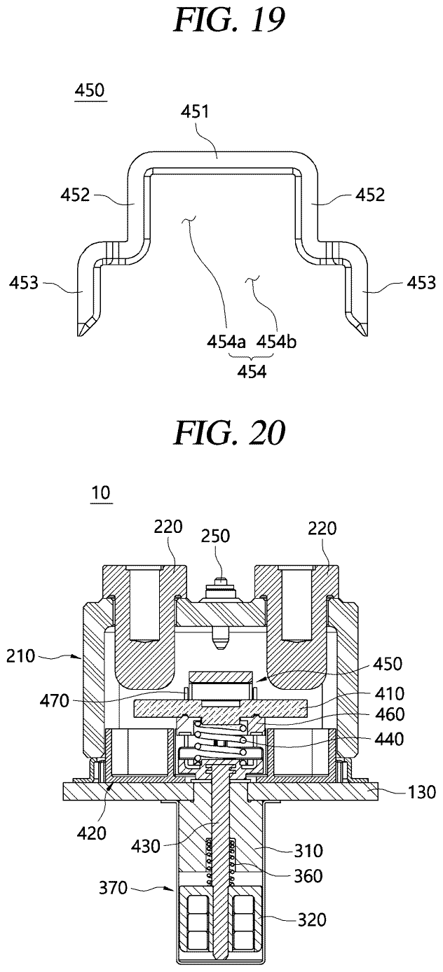

In the embodiment shown in FIGS. 18 and 19, the upper yoke 450 includes a first yoke body 451, a second yoke body 452, a yoke arm 453, a yoke space 454, and a frame coupling groove 455.

The first yoke body 451 constitutes a portion of the upper yoke 450. The first yoke body 451 surrounds the movable contact 410 on one side in the height direction, for example, on the upper side in the shown embodiment. The first yoke body 451 is arranged to face the lower yoke 460 with the movable contact 410 located therebetween.

The first yoke body 451 is continuous with the second yoke body 452 at a certain angle. The first yoke body 451 surrounds the yoke space 454 and the movable contact 410 accommodated in the yoke space 454 on one side in the height direction, for example, on an upper side in the shown embodiment.

The first yoke body 451 may have any shape which can constitute a portion of the upper yoke 450 and surround the movable contact 410 in the height direction. In the shown embodiment, the first yoke body 451 has a shape of a polygonal plate which has a length in the front-rear direction, a width in the left-right direction, and a thickness in the up-down direction.

In the embodiment, the length of the first yoke body 451 may be greater than or equal to the width of the movable contact 410, for example, the length in the front-rear direction. The width of the first yoke body 451 may be equal to or smaller than the length of the movable contact 410, for example, the length in the left-right direction.

Longitudinal ends of the first yoke body 451, for example, front and rear ends in the shown embodiment, are each continuous with the second yoke body 452.

The second yoke body 452 constitutes another portion of the upper yoke 450. The second yoke body 452 surrounds the movable contact 410 in the width direction, for example, on the front side and the rear side in the shown embodiment.

The second yoke body 452 is continuous with the first yoke body 451 at a certain angle. At this time, the second yoke body 452 may extend toward the shaft holder 431, for example, downward in the shown embodiment. In an embodiment, the certain angle may be a right angle.

The second yoke body 452 is continuous with the yoke arm 453. In an embodiment, the second yoke body 452 and the yoke arm 453 may be continuous with each other by including at least one bent part. In the shown embodiment, a lower end of the second yoke body 452 is continuous with the yoke arm 453.

The second yoke body 452 surrounds the yoke space 454, and the movable contact 410 and the lower yoke 460 accommodated in the yoke space 454, in the longitudinal direction. In the shown embodiment, the second yoke body 452 surrounds the yoke space 454 and the movable contact 410 and the lower yoke 460 accommodated in the yoke space 454 on the front and rear sides.

The second yoke body 452 may be arranged as a plurality of second yoke bodies. The plurality of second yoke bodies 452 may be arranged spaced apart from each other in the longitudinal direction with the yoke space 454 located therebetween. The plurality of second yoke bodies 452 may be continuous with each edge of the first yoke body 451.

In the shown embodiment, the second yoke body 452 is arranged as a pair of second yoke bodies spaced apart from each other in the front-rear direction. The pair of second yoke bodies 452 extend downward at certain angles with the front and rear ends of the first yoke body 451, respectively.

The second yoke body 452 is continuous with the yoke arm 453.

The yoke arm 453 constitutes still another portion of the upper yoke 450. The yoke arm 453 is a portion at which the upper yoke 450 is coupled to the movable frame 420. The yoke arm 453 surrounds, from outside, the part of the movable frame outer wall 421, for example, the portion extending in the left-right direction. In an embodiment, the yoke arm 453 may be in contact with the movable frame outer wall 421.

The yoke arm 453 is continuous with the second yoke body 452. As described above, at least one bent part may be formed at the portion where the yoke arm 453 and the second yoke body 452 are continuous with each other.

The yoke arm 453 surrounds the yoke space 454 in the longitudinal direction. In the shown embodiment, the yoke arm 453 surrounds the part of the movable frame outer wall 421 on each of the front and rear sides.

The yoke arm 453 may be arranged as a plurality of yoke arms. The plurality of yoke arms 453 may be arranged spaced apart from each other in the longitudinal direction with the movable frame 420 located therebetween. The plurality of yoke arms 453 may each be continuous with the plurality of second yoke bodies 452.

In the shown embodiment, the yoke arm 453 is arranged as a pair of yoke arms paced apart from each other in the front-rear direction. The pair of yoke arms 453 are continuous with the corresponding lower ends of the pair of second yoke bodies 452. At this time, a distance by which the pair of yoke arms 453 are spaced apart may be less than or equal to a distance by which the parts of the movable frame outer walls 421 are spaced apart.

In the embodiment, the yoke arm 453 may be coupled to the movable frame 420 while pressing the movable frame outer wall 421 inward along the width direction of the movable frame 420. Therefore, the coupled state between the movable frame 420 and the upper yoke 450 can be stably maintained.

The yoke space 454 is a space where the upper yoke 450 accommodates the movable contact 410 and the lower yoke 460. The yoke space 454 is a space where the upper yoke 450 at least partially accommodates the movable frame 420.

The yoke space 150 may be defined by being surrounded by the first yoke body 451, the second yoke body 452, and the yoke arm 453. At this time, the yoke space 454 may be open on one side in the height direction, for example, on the lower side in the shown embodiment. The movable contact 410, the movable frame 420, and the lower yoke 460 may be accommodated in the yoke space 454 through the one side, for example, the lower side.

The yoke space 454 may have a shape corresponding to the shapes of the movable contact 410, the movable frame 420, and the lower yoke 460. As best shown in FIG. 19, the yoke space 454 may be formed as a polygonal column-shaped space having a rectangular cross-section and a height in the left-right direction.

The yoke space 454 may be divided into a plurality of small spaces depending on components it accommodates. Any one of the plurality of small spaces may accommodate the movable contact 410 and the lower yoke 460. Another one of the plurality of small spaces may accommodate the movable frame 420.

In the shown embodiment, the yoke space 454 includes a first yoke space 454a and a second yoke space 454b.

The first yoke space 454a is the one space, for example, the space where the movable contact 410 and the lower yoke 460 are accommodated. The first yoke space 454a is defined by being surrounded by the first yoke body 451 and the second yoke body 452.

The upper side of the movable contact 410 accommodated in the first yoke space 454a is surrounded by the first yoke body 451, and the front side and rear side are surrounded by the second yoke body 452. The front and rear sides of the lower yoke 460 accommodated in the first yoke space 454a are surrounded by the second yoke body 452.

The first yoke space 454a communicates with the second yoke space 454b.

The second yoke space 454b is the other space, for example, the space where the movable frame 420 is accommodated. The second yoke space 454b is defined by being surrounded by the yoke arm 453.

The movable frame outer walls 421 of the movable frame 420 accommodated in the second yoke space 454b are surrounded by the yoke arms 453, respectively. In an embodiment, as described above, the movable frame outer wall 421 can be pressed inward by the yoke arm 453.

At this time, the second yoke space 454b may be formed to have a larger volume than the first yoke space 454a. This results from the fact that the volume of the movable frame 420 accommodated in the second yoke space 454b is larger than the volume of the movable contact 410 and the lower yoke 460 accommodated in the first yoke space 454a.

That is, it can be understood that the shape and volume of each of the first yoke space 454a and the second yoke space 454b can change depending on the shape and volume of each of the movable contact 410, the movable frame 420, and the lower yoke 460.

The frame coupling groove 455 is a portion at which the upper yoke 450 is coupled to the movable frame 420. Specifically, the frame coupling groove 455 is detachably coupled to the yoke coupling protrusion 426 of the movable frame 420. In an embodiment, the frame coupling groove 455 may be hook-fitted or snap-fitted to the yoke coupling protrusion 426.

The frame coupling groove 455 is formed in the yoke arm 453. In the shown embodiment, the frame coupling groove 455 is formed through the yoke arm 453 in the thickness direction of the yoke arm 453, for example, in the front-rear direction. In another embodiment, the frame coupling groove 455 may be formed recessed in one surface, which surrounds the second yoke space 454b, of surfaces of the yoke arm 453.

The frame coupling groove 455 may have a shape corresponding to the shape of the yoke coupling protrusion 426. In the shown embodiment, the frame coupling groove 455 is formed as a polygonal column-shaped space having a rectangular cross-section and the height in the front-rear direction.

The frame coupling groove 455 may be arranged as a plurality of frame coupling grooves. The plurality of frame coupling grooves 455 may be formed in each of the plurality of yoke arms 453. At this time, the plurality of frame coupling grooves 455 may also be formed in each yoke arm 453.

In the shown embodiment, a total of two pairs of frame coupling grooves 455 are arranged. A pair of frame coupling grooves 455 are formed in the yoke arm 453 located on the front side. Another pair of frame coupling grooves 455 are formed in the yoke arm 453 located on the rear side. At this time, the frame coupling grooves 455 formed in each yoke arm 453 are spaced apart from each other in the width direction of the yoke arm 453, for example, in the left-right direction in the shown embodiment.

The shape, number, and arrangement of the frame coupling grooves 455 may change depending on the shape, number, and arrangement of the yoke coupling grooves 426.

The lower yoke 460 generates the magnetic attractive force together with the upper yoke 450. As described above, the magnetic attractive force can offset the electromagnetic repulsive force generated between the fixed contact 220 and the movable contact 410.

The lower yoke 460 may also have any shape which can generate the magnetic attractive force together with the upper yoke 450. In an embodiment, similar to the upper yoke 450, the lower yoke 460 may be made of a magnetic substance having magnetism, for example, may be implemented as a permanent magnet.

The lower yoke 460 is located adjacent to the movable contact 410. The lower yoke 460 is located on another side of the movable contact 410 in the height direction of the movable contact 410, for example, the lower side. The lower yoke 460 supports the movable contact 410 from the lower side.

The lower yoke 460 is elastically supported by the movable spring 440. In the shown embodiment, a lower surface of the lower yoke 460 is supported by being in contact with an upper end of the movable spring 440.

The lower yoke 460 is at least partially surrounded by the upper yoke 450. In the shown embodiment, the upper, front, and rear sides of the lower yoke 460 are each surrounded by the upper yoke 450.

In some embodiments, the lower yoke 460 may move together with the movable shaft 430. At this time, when the movable contact 410 moves to be in contact with the fixed contact 220, the lower yoke 460 may be arranged to at least partially overlap the upper yoke 450 along the horizontal direction. A detailed description thereof will be given later.

The movable contact support member 470 suppresses the movable contact 410 from being randomly separated from the movable shaft 430. The movable contact support member 470 is coupled to each of the movable contact 410 and the shaft holder 431.

The movable contact support member 470 may be formed to at least partially surround the movable contact 410. In the shown embodiment, the movable contact support member 470 surrounds a portion of an upper side, a portion of a front side, and a portion of a rear side of the movable contact 410.

The movable contact support member 470 is coupled to the shaft holder 431. One side of the movable contact support member 470 in the height direction of the movable contact support member 480, for example, a lower side in the shown embodiment, may be fixedly coupled to the shaft holder 431.

The movable contact support member 470 may be arranged as a plurality of movable contact support members. The plurality of movable contact support members 470 may be spaced apart from each other along the longitudinal direction of the movable contact 410. The plurality of movable contact support members 470 may support the movable contact 410 at different positions.

In the shown embodiment, the movable contact support member 470 is arranged as a pair spaced apart from each other in the left-right direction.

The movable contact support member 470 may be divided into a plurality of consecutive parts. In the shown embodiment, the movable contact support member 470 includes a first extension portion located on a front side thereof and extending in the up-down direction to surround the front side of the movable contact 410, a second extension portion located on an upper side and extending in the front-rear direction to surround the upper side of the movable contact 410, and a third extension portion located on a rear side and extending in the up-down direction to surround the rear side of the movable contact 410.

At this time, lower ends of the first extension portion and the third extension portion are coupled to the shaft holder 431. Upper ends of the first extension portion and the third extension portion are continuous with front and rear ends of the second extension portion, respectively, at a certain angle. In an embodiment, the certain angle may be a right angle.

The movable contact support member 470 may be configured to support the movable contact 410 in the width direction rather than a surface direction. In other embodiments, the movable contact support member 470 may support the movable contact 410 in a line-contact manner other than a surface-contact manner. Accordingly, the rigidity of the movable contact support member 470 can increase with respect to a vibration force applied by the movable contact 410, thereby effectively suppressing random vibration of the movable contact 410.

In an embodiment, the movable contact support member 470 may be arranged to be in contact with the movable contact 410. In the embodiment, arbitrary rotation or separation of the movable contact 410 can be more effectively suppressed.

In another embodiment, the movable contact 410 may have a groove formed to correspond to the movable contact support member 470. In the embodiment, the coupled state of the movable contact 410 and the movable contact support member 470 can be maintained more stably.

As described above, when the movable core 320 moves, the movable shaft 430 coupled to the movable core 320 can move together. At this time, the movable contact 410, the movable spring 440, the lower yoke 460, and the movable contact support member 470 move together with the movable shaft 430, but the upper yoke 470 does not move.

Accordingly, the strength of force required for the movement of the movable contact 410 and other components can be reduced compared to the case where the upper yoke 450 moves together with the movable shaft 430. Therefore, even though the strength of a magnetic force between the fixed core 310 and the movable core 320 is reduced, the movement of the movable contact 410 and the contact of the movable contact 410 with the fixed contact 220 can be easily performed.

Furthermore, the upper yoke 450 can be maintained at a preset position regardless of the movement of the movable shaft 430. Therefore, a distance between the upper yoke 450 and the lower yoke 460 can be reduced compared to the case where the upper yoke 450 moves together with the movable shaft 430.

This can result in applying a sufficiently strong magnetic attractive force between the upper yoke 450 and the lower yoke 460, so as to effectively offset an electromagnetic repulsive force generated between the fixed contact 220 and the movable contact 410.

Furthermore, the upper yoke 450 is formed to surround at least a portion of the movable contact 410. That is, the upper yoke 450 itself can be configured to suppress arbitrary rotation or movement of the movable contact 410. Accordingly, even if the movable contact support member 470 is not arranged, the arbitrary rotation or movement of the movable contact 410 can be suppressed even by the upper yoke 450.

Referring to FIGS. 20 to 23, an example of a process of operating the electromagnetic contactor 10 according to an embodiment is shown.

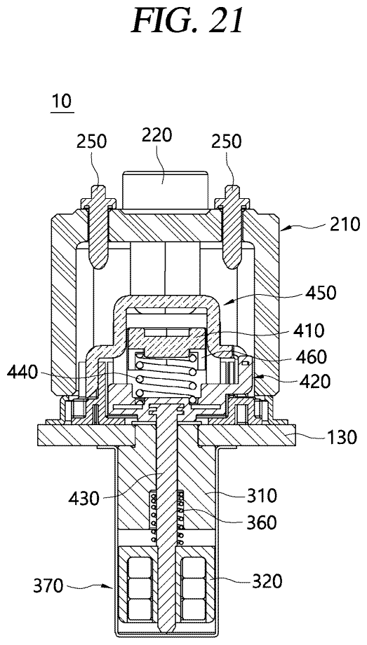

FIGS. 20 and 21 show a state in which the electromagnetic contactor 10 blocks an electrical connection between the external power source (not shown) and the external load (not shown). In the shown embodiment, the movable contact 410 is arranged spaced apart from the fixed contact 220 in the up-down direction.

At this time, as shown in FIG. 21, a lower end of the second yoke body 452, among the components of the upper yoke 450 is located lower than an upper end of the lower yoke 460. In the embodiment, it can be said that the upper yoke 450 and the lower yoke 460 are arranged to at least partially overlap each other along the horizontal direction.

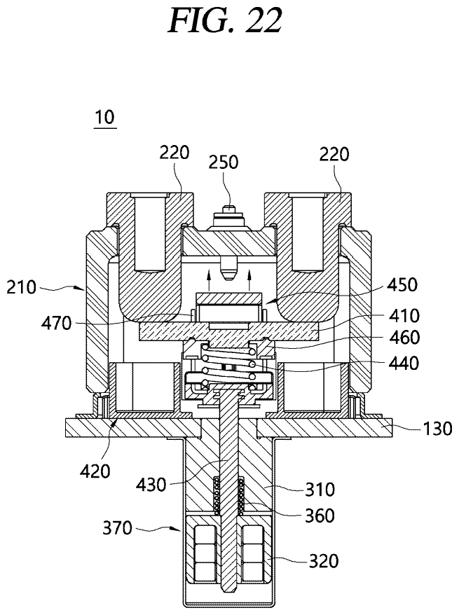

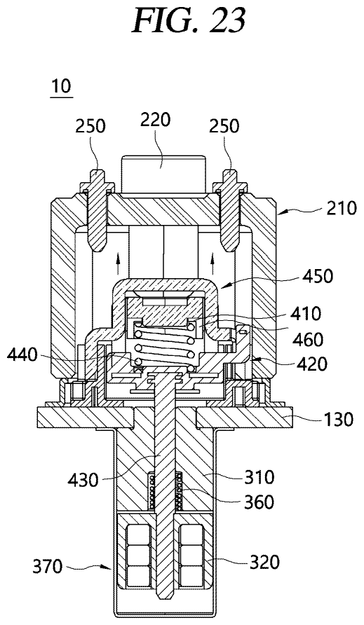

FIGS. 22 and 23 show a state in which the electromagnetic contactor 10 allows the electrical connection between the external power source (not shown) and the external load (not shown). In the shown embodiment, the movable contact 410 is in contact with the fixed contact 220. Accordingly, an electromagnetic repulsive force may be generated between the movable contact 410 and the fixed contact 220.

At this time, as shown in FIG. 23, a lower end of the upper yoke 450 is located lower than an upper end of the lower yoke 460. In other embodiments, the upper yoke 450 and the lower yoke 460 are arranged to at least partially overlap each other along the horizontal direction. At this time, it will be understood that an overlap area between the upper yoke 450 and the lower yoke 460 in the state shown in FIG. 23 is wider than an overlap area between the upper yoke 450 and the lower yoke 460 in the state shown in FIG. 21.

Accordingly, in the state shown in FIGS. 22 and 23, that is, in the state where the movable contact 410 is in contact with the fixed contact 220 to be electrically connected to the fixed contact 220, the strength of the magnetic attractive force generated between the upper yoke 450 and the lower yoke 460 can further increase. Therefore, the contact state between the movable contact 410 and the fixed contact 220 can be stably maintained.

In the embodiments shown in FIGS. 20 to 23, the movable contact 410 and the lower yoke 460 are arranged to be surrounded by the first yoke body 451 and the second yoke body 452 in the height direction (for example, on the upper side thereof) and the width direction (for example, on the front and rear sides).

Accordingly, arbitrary rotation or vibration of the movable contact 410 and the lower yoke 460 supporting the movable contact 410 can be suppressed, thereby improving the contact reliability between the movable contact 410 and the fixed contact 220.

Although the embodiment of the disclosure has been described, the idea of the disclosure is not limited to the embodiment presented in this specification, and those skilled in the art who understand the scope of the disclosure can easily propose other embodiments by addition, change, deletion, etc. of components within the scope of the same technical idea, but it should be understood that those addition, change, deletion, etc. are embraced within the technical idea of the disclosure.
10: Electromagnetic contactor 100: Housing
110: Upper housing 120: Lower housing
130: Support plate 140: Inner housing
141: Inner housing body 142: Fixed contact through hole
143: Auxiliary contact through hole 144: Magnetic member accommodating portion
145: Arc chamber accommodation space 200: Opening and closing unit
210: Arc Chamber 220: Fixed contact
230: Magnetic support member 231: Magnetic support surface
232: Magnet exposure surface 233: Housing accommodation space
240: Magnetic member 241: First magnetic member
242: Second magnetic member 250: Auxiliary contact
260: Auxiliary contact cable 300: Core unit
310: Fixed core 320: Movable core
330: Core Yoke 340: Bobbin
350: Coil 360: Return spring
370: Cylinder 400: Movable contact assembly
410: Movable contact 420: Movable frame
421: Movable frame outer wall 422: Movable frame inner wall
423: Movable shaft accommodating portion 424: Movable shaft coupling portion
425: Cut groove 426: Yoke coupling protrusion
426a: First protrusion extension portion 426b: Second protrusion extension portion
430: Movable shaft 431: Shaft holder
440: Movable spring 450: Upper yoke
451: First yoke body 452: Second yoke body
453: Yoke Arm 454: Yoke Space
454a: First yoke space 454b: Second yoke space
455: Frame coupling groove 460: Lower yoke
470: Movable contact support member

1. A movable contact assembly comprising:
a movable contact arranged to be movable in a direction toward a fixed contact and in a direction opposite to the fixed contact;
a lower yoke located adjacent to the movable contact and arranged to be movable together with the movable contact;
an upper yoke partially surrounding the movable contact and configured to generate a magnetic attractive force together with the lower yoke; and
a movable frame coupled to the upper yoke to support the upper yoke, and to which the movable contact and the lower yoke are movably coupled.

2. The movable contact assembly of claim 1, wherein
the lower yoke is arranged to at least partially overlap the upper yoke along a width direction of the lower yoke.

3. The movable contact assembly of claim 1, wherein
the upper yoke comprises:
a first yoke body surrounding the movable contact on one side thereof in a height direction; and
a second yoke body continuous with the first yoke body and surrounding the movable contact and the lower yoke in a width direction.

4. The movable contact assembly of claim 3, wherein
the second yoke body is arranged as a plurality of second yoke bodies arranged spaced apart from each other with the movable contact and the lower yoke located therebetween.

5. The movable contact assembly of claim 3, wherein
the second yoke body extends in the direction opposite to the fixed contact,
the lower yoke is arranged to at least partially overlap the second yoke body along the width direction of the lower yoke.

6. The movable contact assembly of claim 3, wherein
the upper yoke comprises a yoke arm continuous with the second yoke body and surrounding the movable frame in the width direction.

7. The movable contact assembly of claim 6, wherein
the second yoke body and the yoke arm are each arranged as a pair spaced apart from each other along the width direction, and
a distance between the pair of second yoke bodies is shorter than a distance between the pair of yoke arms.

8. The movable contact assembly of claim 6, wherein
the movable frame comprises:
a movable frame outer wall extending along an outer periphery of the movable frame, and surrounding the yoke arm in the width direction; and
a yoke coupling protrusion formed protruding on the movable frame outer wall, and
the upper yoke comprises a frame coupling groove formed in the yoke arm and detachably coupled to the yoke coupling protrusion.

9. The movable contact assembly of claim 8, wherein
the frame coupling groove is formed through the yoke arm in a thickness direction of the yoke arm.

10. The movable contact assembly of claim 8, wherein
the frame coupling groove is recessed in one surface of the yoke arm facing the movable frame outer wall.

11. The movable contact assembly of claim 8, wherein
the yoke arm is arranged as a pair spaced apart from each other in the width direction,
the movable frame outer wall is arranged as a pair spaced apart from each other in the width direction, and
a distance between the pair of yoke arms is shorter than or equal to a distance between the pair of movable frame outer walls.

12. An electromagnetic contactor comprising:
a housing having a space formed therein;
an opening and closing unit coupled to the housing and electrically connected to each of external power source and load; and
a movable contact assembly movably accommodated in the housing, and configured to be brought into contact with the opening and closing unit to be electrically connected and spaced apart from the opening and closing unit to be electrically disconnected,
wherein the opening and closing unit comprises:
a fixed contact having one side partially exposed to outside of the housing, and electrically connected to each of the external power source and load; and
an arc chamber accommodating another side of the fixed contact, and
the movable contact assembly comprises:
a movable contact accommodated in the arc chamber to be movable in a direction toward the fixed contact and in a direction opposite to the fixed contact;
a lower yoke accommodated in the arc chamber, arranged to face the fixed contact with the movable contact located therebetween, and configured to be movable together with the movable contact;
a movable frame movably supporting the movable contact point and the lower yoke; and
an upper yoke accommodated in the arc chamber, fixedly coupled to the movable frame, located between the movable contact and the fixed contact to partially surround the movable contact, and generating a magnetic attraction force together with the lower yoke.

13. The electromagnetic contactor of claim 12, wherein
the lower yoke is arranged to be movable between a first position, at which the movable contact is in contact with and electrically connected to the fixed contact, and a second position, at which the movable contact is spaced apart from the fixed contact, and
the lower yoke is arranged to at least partially overlap the upper yoke along the width direction.

14. The electromagnetic contactor of claim 12, wherein
the movable contact and the lower yoke are formed to have a length in one direction and a width in another direction, and
the upper yoke comprises:
a first yoke body extending in the another direction and surrounding the movable contact in a height direction; and
a second yoke body continuous with the first yoke body, and extending in the height direction to surround the movable contact and the lower yoke in the another direction.

15. The electromagnetic contactor of claim 14, wherein
the second yoke body is arranged as a pair continuous with corresponding longitudinal ends of the first yoke body, and
the pair of second yoke bodies are configured to support the movable contact and the lower yoke in the another direction.
